(19) United States
(12) Patent Application Publication
(10) Pub. No.: US 2024/0270280 A1
(43) Pub. Date: Aug. 15, 2024

(54) AUTOMATED TRAVEL DEVICE

(71) Applicant: DENSO CORPORATION, Kariya-city (JP)

(72) Inventors: Takuya KUME, Kariya-city (JP); Kazuki IZUMI, Kariya-city (JP)

(21) Appl. No.: 18/632,037

(22) Filed: Apr. 10, 2024

Related U.S. Application Data
(63) Continuation of application No. PCT/JP2022/038235, filed on Oct. 13, 2022.

(30) Foreign Application Priority Data
Oct. 22, 2021 (JP) 2021-173417
Sep. 27, 2022 (JP) 2022-154048

(51) Int. Cl. B60W 60/00; B60W 30/16; G08G 1/01; G08G 1/0962

(52) U.S. Cl. CPC B60W 60/001; B60W 30/162; B60W 60/0053; G08G 1/0145; G08G 1/0962; B60W 2420/403; B60W 2552/05; B60W 2754/30

(57) ABSTRACT

A vehicle control unit is configured to execute automated driving control to allow a subject vehicle to travel autonomously along a predetermined scheduled travel route based on a signal from a surrounding monitoring sensor. A merge-point recognition unit is configured to recognize a merge point with a main road, on which the subject vehicle travels, based on at least one of map data, a detection result of the surrounding monitoring sensor, or data acquired from an external apparatus via wireless communications. The vehicle control unit is configured, during execution of the automated driving control, to perform control to change a running position of the subject vehicle with respect to a surrounding vehicle on the main road, when a remaining distance to the merge point reaches less than a predetermined value.

### CROSS REFERENCE TO RELATED APPLICATION

The present application is a continuation application of International Patent Application No. PCT/JP2022/038235 filed on Oct. 13, 2022, which designated the U.S. and claims the benefit of priority from Japanese Patent Applications No. 2021-173417 filed on Oct. 22, 2021 and No. 2022-154048 filed on Sep. 27, 2022. The entire disclosures of all of the above applications are incorporated herein by reference.

### TECHNICAL FIELD

The present disclosure relates to an automated travel device.

### BACKGROUND

Automated travel devices for vehicles have been developed.

### SUMMARY

According to an aspect of the present disclosure, an automated travel device comprises a vehicle control unit configured to execute automated driving control to allow a subject vehicle to travel autonomously along a predetermined scheduled travel route based on a signal from a surrounding monitoring sensor.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating the configuration of an automated driving system;

FIG. 2 is a diagram illustrating a road structure related to a merge point;

FIG. 3 is a functional block diagram of an automated driving ECU;

FIG. 4 is a flowchart illustrating an example of merging vehicle response processing;

FIG. 5 is a diagram illustrating an example image of deceleration alert;

FIG. 6 is a flowchart illustrating an example of response plan confirmation processing to a merging vehicle;

FIG. 7 is a flowchart illustrating another example of the merging vehicle response processing;

FIG. 8 is a flowchart illustrating another example of the merging vehicle response processing;

FIG. 9 is a flowchart illustrating another example of the merging vehicle response processing;

FIG. 10 is a flowchart illustrating another example of the merging vehicle response processing;

FIG. 11 is a flowchart illustrating another example of the merging vehicle response processing;

FIG. 12 is a flowchart illustrating another example of the merging vehicle response processing;

FIG. 13 is a flowchart illustrating an example operation of a processor to change the permissible merge number; and

FIG. 14 is a diagram illustrating an example of setting screen for a response plan to a merging vehicle.

### DETAILED DESCRIPTION

Hereinafter, examples of the present disclosure will be described.

According to an example of the present disclosure, an automated travel device inhibits the start of automated driving mode if the subject vehicle travels within a section including a merge point or a dividing point. According to an example of the present disclosure, an assumable configuration permits start of the automated driving, when there is no merging vehicle, and when the lead time to collision with a merging vehicle is equal to or higher than a predetermined value, even when it travels around a merge point.

The above configuration is designed on the precondition that, for example, the vehicle is in a state before the automated driving is started, i.e., the vehicle is being operated in manual mode. There is plenty of room for consideration about a system response plan to a merging vehicle after the start of automated driving, i.e., during performance of automated driving.

According to an example of the present disclosure, an automated travel device, comprises:
a vehicle control unit configured to execute automated driving control to allow a subject vehicle to travel autonomously along a predetermined scheduled travel route based on a signal from a surrounding monitoring sensor; and
a merge-point recognition unit configured to recognize a merge point with a main road, on which the subject vehicle travels, based on at least one of map data, a detection result of the surrounding monitoring sensor, or data acquired from an external apparatus via wireless communications.

The vehicle control unit is configured, during execution of the automated driving control, to perform control to change a running position of the subject vehicle with respect to a surrounding vehicle on the main road, when a remaining distance to the merge point reaches less than a predetermined value.

According to an example of the present disclosure, a merging vehicle response control method is to be implemented by at leas one processor. The merging vehicle response control method comprises:
executing automated driving control to allow a subject vehicle to travel autonomously along a predetermined scheduled travel route based on a signal from a surrounding monitoring sensor;
recognizing a merge point with a main road, on which the subject vehicle travels, based on at least one of map data, a detection result of the surrounding monitoring sensor, or data acquired from an external apparatus via wireless communications; and
starting control to change a running position of the subject vehicle with respect to a surrounding vehicle on the main road, when a remaining distance to the merge point reaches less than a predetermined value, during execution of the automated driving control.

In the above device/method, based on the fact that the remaining distance to the merge point reaches less than a predetermined value, control is executed to change a running position of the subject vehicle with respect to surrounding vehicles on the main road. Therefore, a space is created to make a merging vehicle easy to merge in front of/behind/lateral to the subject vehicle. Thus, the merging vehicle is able to merge with ensuring a sufficient inter-vehicle distance from the subject vehicle, so that it is possible to reduce, in advance, the number of merging vehicles itself which can exert influence on running of the subject vehicle. It is also possible to inhibit an event of a vehicle intending to merge forcibly in front of or behind the subject vehicle from a merging road. As a result, it is possible to reduce the risk of running environment falling into difficulties of continuing the automated driving (so-called system limit). Thus, it is possible to enhance the continuity of automated driving, and then to improve the convenience of automated driving.

### INTRODUCTION

An example of embodiments of the present disclosure will be described with reference to the accompanying drawings. The present disclosure is not intended to be limited to the following embodiments, and the present disclosure may be implemented with various changes made within the scope and sprit thereof rather than the following.

For example, the present disclosure may be implemented using an appropriate combination of various supplemental additions, modifications and the like without technological conflict. Members having the same or similar functions are indicated with like reference signs, and a description may be omitted in some cases. If mention is made of only part of configuration, a description given earlier than the part may be applied to the remainder.

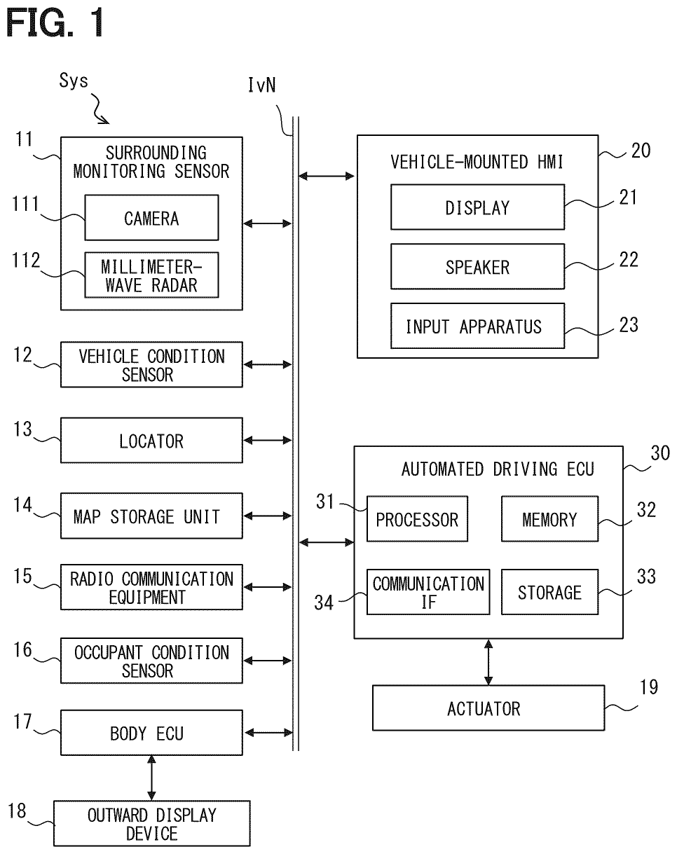

FIG. 1 is a diagram illustrating an example of the schematic configuration of an automated driving system Sys according to the present disclosure. The automated driving system Sys is able to be equipped on a vehicle capable of running on a road. A vehicle to which the automated driving system Sys is applied may be a four-wheel automobile, a two-wheel automobile, a three-wheel automobile, a bus, a truck, a tanker truck or the like. A vehicle to which the automated driving system Sys is applied may be an owner car owned by an individual or may be a shared car or a rental car. The shared car is a vehicle available for the carsharing service. The rental car is a vehicle available for the vehicle lending service. A vehicle equipped with the automated driving system Sys may be hereinafter mentioned as a subject vehicle. The automated driving system Sys described below is made implementable by being modified as appropriate to conform to local laws and customs where the automated driving system Sys is used, characteristics/equipped equipment of the system-equipped vehicle, and/or the like. A system described below refers to the automated driving system Sys unless otherwise specified.

As used herein, the subject vehicle is an electric motor vehicle by way of example. The subject vehicle may be an engine vehicle. The electric motor vehicle may include, as well as an electric automobile, a plug-in hybrid vehicle, a hybrid vehicle and a fuel cell vehicle. The engine vehicle corresponds to a vehicle mounted with only an engine as a drive source, in which the vehicle runs on fuel such as gasoline, light oil and/or the like. The electric automobile refers to a vehicle mounted with only a motor as a drive source. The plug-in hybrid vehicle and the hybrid vehicle refer to a vehicle mounted with an engine and a motor as a power source.

A driver in the present disclosure refers to a person sitting on a driver seat, i.e., a driver's seat occupant regardless of whether or not the driver is actually driving. For example, the driver in the present disclosure can refer to a person who should receive authority and responsibility of driving operation from the automated driving system Sys at the end of automated driving. The driver described in the present disclosure may be replaced with the driver's seat occupant. The subject vehicle may be a remote-controlled vehicle that is remotely operated by an operator existing outside of the vehicle. A person taking over the driving operation from the automated driving system Sys may be the operator existing outside of the vehicle. The operator as used herein refers to a person having authority to control the vehicle by remote operation from outside of the vehicle. The operator may fall into the concept of driver/driver's seat occupant. A target to be notified of various items of information by the system may be the operator.

The automated driving system Sys provides so-called automated driving capability of allowing the subject vehicle to run autonomously along a predetermined route. For the degree of automation of driving operation (hereinafter referred to as “automation level”), a plurality of levels can exist as defined by, for example, Society of Automotive Engineers (SAE International). For example, the automation level can be classified into six levels of the following Level 0 to Level 5.

At Level 0, the driver performs all driving tasks without system intervention. The driving tasks include, for example, steering, acceleration and deceleration. The driving tasks include monitoring the vehicle environment such as, e.g., an area ahead of the vehicle and the like. Level 0 corresponds to a so-called completely manual driving level. At Level 1, the system supports any of steering, acceleration and deceleration. Level 2 refers to a level at which the system supports one or more of steering operation, acceleration operation and deceleration operation. Levels 1 and 2 correspond to so-called driving assist level.

Level 3 refers to a level at which the system performs all driving tasks within Operational Design Domain (ODD), while the operation authority is transferred from the system to the driver in emergency. ODD is for specifying the feasible conditions for automated driving, such as, e.g., a running position located in a limited-access road and/or the like. Level 3 corresponds to so-called conditional automated driving.

At Level 4, the system performs all driving tasks, except under specific circumstances such as a predetermined unavailable road, extreme environments and the like. Level 4 corresponds to a level at which the system performs all driving tasks within ODD. Level 4 corresponds so-called high automated driving. At Level 5, the system is able to perform all driving tasks under all environments. Level 5 corresponds to so-called full automated driving.

Automation Levels 3 to 5 are levels corresponding to automation levels at which the driver is not required to monitor surroundings, stated another way, levels corresponding to automated driving. The automated driving system Sys is configured to able to perform automated driving control corresponding to Automation Level 3. Understandably, the automated driving system Sys may be configured to able to perform automated driving control corresponding to Automation Level 4 or 5.

A preceding vehicle as used in the present disclosure refers to a vehicle of vehicles existing in front of the subject vehicle, the vehicle running in the same lane as the subject vehicle and being located closest to the subject vehicle. In the present disclosure, the road on which the subject vehicle runs is referred to as a subject vehicle running path. A subject vehicle lane described hereinafter refers to a lane of lanes included in the subject vehicle running path, the subject vehicle running in the lane. The subject vehicle lane may also be called an “ego lane”.

Further, a merge point in the present disclosure is a point where roads merge with each other. One of the two roads connected together at the merge point survives even after the merge point, and the one road corresponds to the main road (i.e., merged road). The other road disappears after the merge point, and corresponds to the merge road. The merge road may translate to a branch road, a sub road or the like. Another vehicle(s) running on the merge road corresponds to a merging vehicle(s). The following description is given mainly of the case where the subject vehicle running path corresponds to a main road. Whether or not the subject vehicle running path corresponds to the main road can be determined based on map data and/or the like. In general, the main road can be defined as being larger in road structure such as a road width and the like.

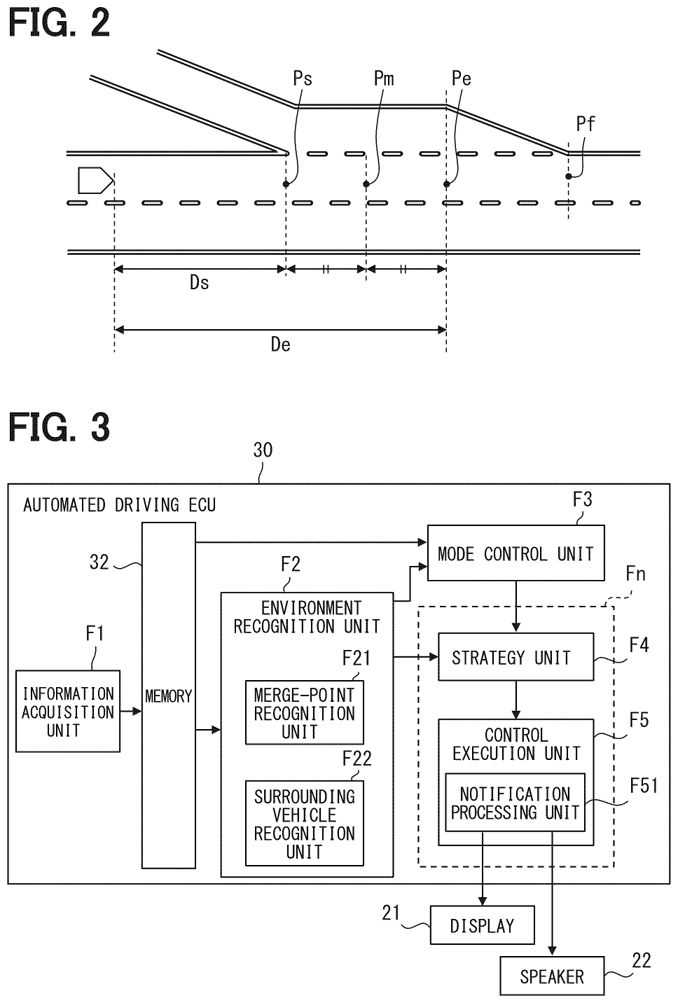

As illustrated in FIG. 2, some merge roads include a side-by-side section extending alongside the main road. The side-by-side section can be called an acceleration section or deceleration section. Because of the above-described section, the merge point may be implemented as a merge section having a certain length for providing smooth merge. The phrase “merge point” in the present disclosure contains the concept of an area or a section having a predetermined length.

In the present disclosure, by way of example, the starting end of the side-by-side section is referred to as a merging start point Ps, and the ending end of the side-by-side section is referred to as a merging end point Pe. Traffic bollards and/or the like may be arranged on the border between the side-by-side section and the main road in order to prompt merge at the ending end of the side-by-side section (i.e., zipper technique). In this case, the ending end of a section with the traffic bollards arranged therein corresponds the merge starting point Ps. The zipper technique can be referred to as a fastener scheme or the like.

In the case where the merge point is implemented as a section having a predetermined length, for example, the positional coordinates of the merging start point Ps may be employed as coordinates typically representing the position of the merge point. As another embodiment, the center of the merge section, that is, a midpoint Pm between the merging start point Ps and the merging end point Pe, may be assumed as a representing position of the merge point. The representing position of the merge point may be a point located 5 meters before the merging end point Pe. The “before” in the present disclosure corresponds to the opposite side to the traveling direction specified for a road.

FIG. 2 is a diagram schematically illustrating a road structure around a merge point. Ds in FIG. 2 shows a merge-start remaining distance which is a distance remaining from the subject vehicle to the merging start point Ps. De shows a merge-end remaining distance which a distance remaining from the subject vehicle to the merging end point Pe. FIG. 2 illustrates an aspect where a point at which the lane width in the side-by-side section begins to decrease is assumed as the merging end point Pe. As another aspect, as illustrated by point Pf in FIG. 2, the point at which the side-by-side section completely disappears may be employed as a merging end point. A point located 5 meters before the point at which the side-by-side section completely disappears may be employed as a merging end point. The coordinates of the merge point used in various controls described later may be any of the merging start point Ps, the merging end point Pe and the representing position.

### Overview Configuration of Automated Driving System Sys

The automated driving system Sys is equipped with various configurations illustrated in FIG. 1 by way of example. Specifically, the automated driving system Sys is equipped with a surrounding monitoring sensor 11, a vehicle condition sensor 12, a locator 13, a map storage unit 14, radio communication equipment 15, an occupant condition sensor 16, a body ECU 17, an outward display device 18, and a travel actuator 19. The automated driving system Sys is also equipped with a vehicle-mounted HMI 20 and an automated driving ECU 30. ECU stands for Electronic Control Unit, and means an electronic controller. HMI stands for Human Machine Interface.

The automated driving ECU 30 is intercommunicatively connected to each of the above apparatuses/sensors such as the surrounding monitoring sensor 11 and the like via an intra-vehicle network IvN. The intra-vehicle network IvN is a communication network established within the vehicle. For the standards for the intra-vehicle network IvN, various standards, such as Controller Area Network (hereinafter referred to as CAN, Registered Trademark), Ethernet (Registered Trademark), and the like, are adoptable. Some of the apparatuses/sensors may be connected directly to the automated driving ECU 30 through dedicated signal lines. The interconnection manner between apparatuses is able to be changed as appropriate.

The surrounding monitoring sensor 11 is an autonomous sensor that monitors surrounding environment around the subject vehicle. The surrounding monitoring sensor 11 is able to detect a prescribed moving object and a prescribed stationary object in a detection range around the subject vehicle. The automated driving system Sys can be equipped with a plurality of types of surrounding monitoring sensors 11. The automated driving system Sys is equipped with, for example, a camera 111 and a millimeter-wave radar 112 as the surrounding monitoring sensor 11.

The camera 111 is, for example, a so-called front camera, which is installed to image an area ahead of the subject vehicle at a predetermined angle. The camera 111 is mounted on an upper end portion on the cabin side of the windshield, a front grille, a rooftop and/or the like. The camera 111 can include a camera ECU in addition to a camera body that generates an image frame, the camera ECU being an ECU that applies recognition processing to the image frame in order to detect a predetermined object to be detected. The camera body includes, at least, an image sensor and a lens. The camera ECU consists principally of CPU (Central Processing Unit), GPU (Graphics Processing Unit), and/or the like. The camera ECU uses, for example, a discriminator adopting deep learning to detect and identify an object registered as a detection target. CNN (Convolutional Neural Network), DNN (Deep Neural Network) and/or the like may be employed as deep learning techniques.

The objects to be detected by the camera 111 include, for example, a moving object such as a pedestrian, other vehicles, and the like. The objects to be detected by the camera 111 include natural and manmade features such as a roadside, traffic markings and structures placed along a road. The traffic markings include lane demarcation lines indicating boundary of a lane, a crosswalk, a stop line, a channelizing island, a safety zone, a regulatory arrow, and the like. The structures placed along the road include road signs, guardrails, curbstones, utility poles, traffic lights and the like. The camera 111 can additionally detect an on/off state of a lighting apparatus, such as a hazard light and a turn signal, of a vehicle ahead.

The automated driving system Sys can be equipped with a plurality of cameras 111. For example, the automated driving system Sys may be equipped with, in addition to the front camera, a side camera that images an area lateral to the vehicle, and/or a rear camera that images an area behind the vehicle. Another ECU, e.g., the automated driving ECU 30 and/or the like, may have a function of analyzing a camera image to detect an object to be detected. The functional layout in the automated driving system Sys is able to be changed as appropriate. The camera 111 outputs at least one of: the image data on images around the subject vehicle; and the results of analysis of the image data to the intra-vehicle network IvN as detection information. The automated driving ECU 30 references data flowing in the intra-vehicle network IvN as appropriate.

The millimeter-wave radar 112 is a device that detects a relative position and/or a relative velocity of an object to the subject vehicle by transmitting probing waves, such as millimeter waves or submillimeter waves, toward a predetermined direction, and then by analyzing received data on reflected waves resulting from reflection of the transmitted waves off the object to return to the device. The automated driving system Sys can be equipped with a plurality of millimeter-wave radars 112 with different detection areas of interest. For example, the automated driving system Sys is equipped with a front millimeter-wave radar and a rear millimeter-wave radar as the millimeter-wave radars 112. The front millimeter-wave radar is the millimeter-wave radar 112 that transmits the probing waves toward an area ahead of the vehicle. For example, the front millimeter-wave radar is installed on the front grille and/or front bumper. The rear millimeter-wave radar is the millimeter-wave radar 112 that transmits the probing waves toward an area behind the vehicle. For example, the rear millimeter-wave radar is installed on the rear bumper. Each millimeter-wave radar 112 generates data showing a relative position and a relative velocity of a detected object, and then outputs the data as a detection result to the automated driving ECU 30 and/or the like. The objects to be detected by the millimeter-wave radar 112 include manholes (iron plates), three-dimensional structures as landmarks and the like, as well as other vehicles, pedestrians and the like.

The automated driving system Sys may be equipped with LiDAR, a sonar, and/the like, in addition to the camera 111 and the millimeter-wave radar 112, as the surrounding monitoring sensor 11. LiDAR stands for Light Detection and Ranging or Laser Imaging Detection and Ranging. LiDAR is a device emitting laser beams in order to generate 3D point cloud data showing a position of a reflection point in each detection direction. LiDAR is also referred to as a laser radar. The sonar is a device that detects a relative position and/or a relative velocity of an object to the subject vehicle by transmitting ultrasonic waves toward a predetermined direction, and then by analyzing received data on reflected waves resulting from reflection of the transmitted waves off the object to return to the device. The automated driving system Sys may be equipped with a plurality of LiDAR and/or a plurality of sonars. The camera 111 and the millimeter-wave radar 112 are merely illustrative of the surrounding monitoring sensor 11 and are not required elements. The combination of the surrounding monitoring sensors 11 equipped in the automated driving system Sys is able to be changed as appropriate. The detection result of each surrounding monitoring sensor 11 is input to the automated driving ECU 30.

The vehicle condition sensor 12 is a sensor group that detects information about the conditions of the subject vehicle. The vehicle condition sensor 12 includes a vehicle speed sensor, a steering angle sensor, an acceleration sensor, a yaw rate sensor, an accelerator pedal sensor, and/or the like. The vehicle speed sensor is a sensor that detects a speed of the subject vehicle. The steering angle senor is a senor that detects a steering angle. The acceleration sensor is a sensor that detects an acceleration acting in the front-rear direction of the subject vehicle, a lateral acceleration acting in the left-right direction, and/or the like. The yaw rate sensor is a sensor that detects an angular velocity of the subject vehicle. The accelerator pedal sensor is a sensor that detects a depression amount/depression force of the accelerator pedal. The vehicle condition sensor 12 outputs, to the intra-vehicle network IvN, data showing current values of the physical state quantity as detection target (i.e., detection results). The types of sensors used as the vehicle condition sensor 12 by the automated driving system Sys may be designed as appropriate, and all of the above-described sensors are not required to be included.

The locator 13 is a device that calculates and outputs positional coordinates of the subject vehicle using navigation signals transmitted from a positioning satellite essentially forming GNSS (Global Navigation Satellite System). The locator 13 includes a GNSS receiver, an inertial sensor and/or the like. The locator 13 uses a combination of a navigation signal received at the GNSS receiver, a measurement result of the inertial sensor, vehicle speed information flowing in the intra-vehicle network IvN and the like to calculate a subject vehicle position and a traveling direction of the subject vehicle, and/or the like in sequence. Then, the locator 13 outputs the result as locator information to the automated driving ECU 30.

The map storage unit 14 is a storage device storing so-called HD (High Definition) map data including road information which is required for automated driving control. The map data stored in the map storage unit 14 includes 3D shapes of roads, installation positions of traffic markings such as lane demarcation lines and the like, installation positions of traffic signs, and the like, with a degree of accuracy required for automated driving and/or the like.

The map data stored in the map storage unit 14 can be updated by, for example, data received from a map server and/or the like by the radio communication equipment 15. The map server is a server placed outside the vehicle and delivering map data, The map storage unit 14 may be a storage device for temporarily holding the map data received from the map server by the radio communication equipment 15 until the expiry of the data. The map data held by the map storage unit 14 may be navigation map data which is map data for navigation, provided that natural/manmade features data on merge points, traffic lights, landmarks and/or the like is included. The functions as the locator 13 may be equipped in a navigation ECU.

The radio communication equipment 15 is an apparatus for establishing wireless communications of the subject vehicle with another apparatus. The radio communication equipment 15 is configured to be capable of establishing cellular communication. The cellular communication is wireless communication based on predetermined long-range wireless communication standards. As long-range wireless communication standards as used herein, various long-range wireless communication standards such as, e.g., LTE (Long Term Evolution), 4G, 5G and the like are adoptable.

The subject vehicle is equipped with the radio communication equipment 15 so that the subject vehicle serves as a connected car with Internet access. For example, by cooperation with the radio communication equipment 15, the automated driving ECU 30 may download map data based on the current location from a map distribution server for use. The radio communication equipment 15 may be configured to be able to establish radio communication directly with another apparatus without a wireless base station in accordance with a scheme based on the long-range wireless communication standards. Thus, the radio communication equipment 15 may be configured to be able to establish cellular V2X (PC5/SideLink/Uu).

The radio communication equipment 15 is also configured to be able to establish short-range communication. The short-range communication in the present disclosure refers to radio communication with a communicable distance limited to within several hundred meters. As short-range wireless communication standards, for example, DSRC (Dedicated Short Range Communications) according to IEEE 802.11p standard, WiFi (registered trademark) and the like are adoptable. The short-range communication scheme may be the above-described cellular V2X. The radio communication equipment 15 may be configured to be able to establish only one of the cellular communication and the short-range communication. The radio communication equipment 15 may be configured to be able to establish communication based on BLE (Bluetooth (registered trademark) Low Energy) standards and/or the like.

The radio communication equipment 15 can receive dynamic map data related to the travel route of the subject vehicle from external apparatus such as a map server, a traffic information center, a roadside unit and/or another vehicle. The roadside unit is a wireless communication facility installed along a road. The dynamic map data is data about elements of which, for example, existing conditions and/or position can change in one second unit, one minute unit or one hour unit. For example, information showing positions of a merging vehicle, speeds and the like corresponds to the dynamic map data. Further, point-by-point road surfaces conditions, weather, a falling object, lane restriction, a construction section, a traffic congestion section and the like correspond to dynamic map elements. Data about dynamic map elements may be received, together with static map data, in the manner of streaming delivery from the map server.

The dynamic map data acquired by the radio communication equipment 15 is temporarily stored in the map storage unit 14, which is then read by locator 13 as appropriate to be output to the automated driving ECU 30. The dynamic map data acquired by the radio communication equipment 15 may be provided to the automated driving ECU 30 without the locator 13 and the map storage unit 14. In another way, the radio communication equipment 15 may receive vehicle information from surrounding vehicles through the vehicle-to-vehicle communication. The vehicle information can include a speed, a current location, operating condition of the turn signal, an acceleration and the like. The surrounding vehicles as used herein refers to vehicles existing within a vehicle-to-vehicle communicable range, for example, vehicles existing within 200 meters from the subject vehicle.

The occupant condition sensor 16 is a sensor that detects conditions of the driver. The automated driving system Sys can be equipped with a plurality of types of occupant condition sensors 16. For example, the automated driving system Sys is equipped with, for example, a driver state monitor (hereinafter referred to as a “DSM”). The DSM is a sensor that detects sequentially driver's conditions based on face images of the driver. Specifically, the DSM uses a near-infrared camera to image a face portion of the driver, and then performs image recognition processing on the resultant image, so that the DSM sequentially detects a direction of driver's face, a direction of a line of sight, the degree of eye opening, and/or the like. The infrared camera of the DSM is installed such that the face of the driver is able to be imaged, and therefore the camera is placed, for example, on an upper face of a steering column cover, an upper face of an instrument panel, an upper end portion of a windshield, and/or the like, with an attitude orienting the optical axis toward a head rest of a driver's seat. The DSM as the occupant condition sensor 16 sequentially outputs, to the intra-vehicle network IvN, information showing the direction of driver's face, a direction of a line of sight, the degree of eye opening, and/or the like which are determined from the taken image, as driver condition data. The camera essentially forming the DSM may be a visible light camera.

The body ECU 17 is an ECU that comprehensively controls the vehicle-mounted equipment in the body system mounted on the vehicle. The vehicle-mounted equipment in the body system includes, for example, the outward display device 18, the lighting apparatus such as the headlights, a door lock motor and/or the like. The outward display device 18 is, for example, a projector projecting an image for communication with a driver of another vehicle on a road surface or a window glass. The outward display device 18 is installed, for example, on the cabin ceiling portion (e.g., around an upper end of a window frame portion) with an attitude allowing emitted light to impinge on a side window. The outward display device 18 may be installed on a side mirror in such a manner as to project an image onto a road surface near a vehicle. The headlight may be configured to operate as the outward display device 18. The outward display device 18 may be a liquid crystal display with a display screen oriented toward a vehicle lateral or rear direction, and/or the like.

Images assumed as the image for communication with a driver of another vehicle include: an entry permission image for indicating the driver's intention to give the right-of-way at a merge point; an entry prohibition image for prompting the other driver to enter behind the subject vehicle at a merge point; and the like. The entry permission image is an image showing permission to merge between the subject vehicle and the preceding vehicle. The entry prohibition image corresponds to an image showing the intention to give no permission to enter between the subject vehicle and the preceding vehicle. The intention as used herein may be decided by driver's input or may be a control policy of the automated driving system Sys. With the above configuration, smooth communication between the automated driving vehicle and another vehicle is achieved, so that the risk of reduction of the inter-vehicle distance to a predetermined value (e.g., one meter) or lower is able to be reduced.

The outward display device 18 may be a device that displays the intention related to the permission/prohibition of the cutting-in in colors of output light. For example, it may be configured that if the cutting-in is permitted, green or blue light is output, and if cancellation of the cutting-in is requested, yellow or red light is output. The change in display image/lighting color of the outward display device 18 corresponds to a change in operation manner of the outward display device 18. The outward display device 18 may be a device for notifying another traffic, such as other vehicles, pedestrians and/or the like, of whether or not during the automated driving.

The outward display device 18 can be understood as one of devices forming the vehicle-mounted HMI 20.

The vehicle-mounted HMI 20 is an interface group for exchanging information between the occupant and the automated driving system Sys. The vehicle-mounted HMI 20 is equipped with a display 21 and a speaker 22 as a notification device which is a device for notifying the driver of information. The vehicle-mounted HMI 20 also includes an input apparatus 23 as an input interface receiving operation of the occupant.

The automated driving system Sys is equipped with one or more of a head up display (HUD), a meter display and a center display, as the display 21. The HUD is an apparatus that projects image light onto a predetermined region of the windshield in order to show a virtual image perceived by the driver. The meter display is a display placed in a region located in front of the driver seat in the instrument panel. The center display is a display installed in a central portion in the vehicle width direction of the instrument panel. The meter display and the center display can be implemented using a liquid crystal display and/or an organic electroluminescent display. The display 21 displays an image corresponding to an input signal based on a control signal and image signal received from the automated driving ECU 30.

The speaker 22 is an apparatus that outputs sound corresponding to a signal received from the automated driving ECU 30. The sound representation includes notification sound as well as voice, music and/or the like. The automated driving system Sys may be equipped with a vibrator, ambient light and/or the like, as the notification device. The ambient light is an illuminating apparatus with adjustable emission color and adjustable emission intensity, which is implemented by a plurality of LEDs (Light Emitting Device). The ambient light is installed in the instrument panel, the steering wheel and the like.

The input apparatus 23 is an apparatus for receiving instruction operation to the automated driving system Sys from the driver. As the input apparatus 23, a steering switch installed on a spoke portion of the steering wheel, an operation lever installed in a steering column portion, a touch panel stacked on the center display, and the like are adoptable. The automated driving system Sys may be equipped with a plurality of types of the devices described above, as the input apparatus 23. The input apparatus 23 outputs an electric signal corresponding to the operation of the driver as an operation signal to the intra-vehicle network IvN. The operation signal includes information showing the driver's operation contents. The automated driving system Sys receives an instruction regarding the start and the end of the automated driving via the input apparatus 23. The automated driving system Sys receives an instruction regarding the permission/non-permission to merge via the input apparatus 23. The automated driving system Sys may be configured to be able to acquire various driver's instructions including the start/end instruction on the automated driving, through voice input. A device related to voice input such as a microphone and/or the like may also be included in the input apparatus 23. For example, a HCU (HMI Control Unit) may be arranged between the vehicle-mounted HMI 20 and the automated driving ECU 30. The HCU is an apparatus that comprehensively controls information notification to the driver.

The automated driving ECU 30 is an ECU that controls the travel actuator 19 based on the detection results of the surrounding monitoring sensor 11 and/or the like in order to execute a part or all of the driving operation as a substitute for the driver. The automated driving ECU 30 is also referred to as an automated travel device. The travel actuator 19 includes, for example, a brake actuator as a brake apparatus, an electronic throttle, a steering actuator and/or the like. The steering actuator includes an EPS (Electric Power Steering) motor. Other ECUs are arranged between the automated driving ECU 30 and the travel actuator 19. The other ECUs are such as a steering ECU that performs steering control, a power unit control ECU that performs acceleration/deceleration control, a brake ECU and/or the like.

The automated driving ECU 30 is configured to consist mainly of a computer including a processor 31, memory 32, a storage 33, a communication interface 34, a bus interconnecting them, and/or the like. The memory 32 is a volatile, rewritable storage medium. The memory 32 is, for example, RAM (Random Access Memory). The storage 33 is non-volatile and rewritable, such as e.g., flash memory and/or the like. The storage 33 stores a vehicle control program to be executed by the processor 31. The vehicle control program includes a merging vehicle response program to make a strategy for a system response to a merging vehicle. Execution of the vehicle control program by the processor 31 corresponds to execution of a merging vehicle response control method. A processor executing processing related to driving assistance may be installed separately from a processor executing processing related to automated driving. The automated driving ECU 30 is equipped with a plurality of processors 31.

The automated driving ECU 30 has a plurality of operation modes differing in automation level. By way of example, the automated driving ECU 30 as described herein is configured to be able to select among full manual mode, driving assist mode, and automated driving mode. The respective operation modes have different driving task ranges for which the driver is responsible, stated another way, driving task ranges in which the system intervention is required. The system as used herein refers to the automated driving system Sys as described above. The system may be described alternately as the automated driving ECU 30. The operation mode is used interchangeably with the driving mode.

The full manual mode is the operation mode in which the driver performs all the driving tasks. The full manual mode corresponds to Automation Level 0. The driving assist mode is the operation mode in which the system performs any of steering, acceleration and deceleration operations. In the mode, an actual operator of the steering operation in the driving assist mode is the driver, and at least the driver is required to keep watch on the surroundings such as an area ahead of the vehicle and the like. The full manual mode and the driving assist mode are the operation mode in which the driver performs at least some of the driving tasks. Therefore, in the present disclosure, when a distinction is not made between the full manual mode and the driving assist mode, occupant involved mode is also used. The occupant involved mode may be also called a manual driving mode as an antonym of the automated driving mode.

The automated driving mode is the operation mode in which the system performs all the driving tasks. By way of example, the automated mode as described herein is the operation mode in which control corresponding to Automation Level 3 is performed. The automated driving mode corresponds to the operation mode in which the performance of a second task of the drive is permitted. The second task permitted in Level 3 automated driving is limited to a task that allows for immediate return to driving operation, such as book reading, operation of a smartphone. The switchover from the manual driving mode to the automated driving mode can be accomplished based on an operation signal received through the input apparatus 23.

In the automated driving mode, the automated driving ECU 30 performs automatically steering, acceleration and deceleration (i.e., braking) of the vehicle and the like such that the subject vehicle travels along a scheduled travel route toward a destination set by the driver. The automated driving mode is terminated due to driver's operation (i.e., override) as well as system limit, exit from ODD and/or the like. The automated driving ECU 30 may be an apparatus that performs automated driving until a scheduled authority-transfer point which is set at some midpoint in the scheduled travel route to the destination. The scheduled authority-transfer point corresponds to a scheduled ODD exit point.

Examples of ODD include: (a) the running path being a freeway or a limited-access road equipped with a central strip, guardrails and the like; (b) the amount of rainfall at or below a predetermined threshold value; (c) conditions being under traffic congestion conditions; and the like. The limited-access road as used herein is a road into which the entry of pedestrians and bicycles is prohibited, and includes for example, a toll road such as a freeway and the like, and the like. The traffic congestion conditions refer to, for example, conditions in which the running speed is at or lower than a traffic-congestion judgement value (e.g., the order of 30 km/h), and another vehicle exists within a predetermined distance (e.g., 20 meters) ahead of and behind the subject vehicle. In another way, the examples of ODD include: (d) all/the predetermined number or more of surrounding monitoring sensors 11 being normally operated; and (e) no vehicle being parked on a road, and/or the like. A condition for determining whether or not to allow the automated driving, in other words, a detailed condition for defining ODD is able to be changed as appropriate.

### Configuration of Automated Driving ECU 30

The automated driving ECU 30 includes a function unit illustrated in FIG. 3 and implemented by executing an automated driving program. Specifically, the automated driving ECU 30 has an information acquisition unit F1, an environment recognition unit F2, a mode control unit F3, a strategy unit F4, and a control execution unit F5.

The information acquisition unit F1 is configured to acquire various items of information for performing vehicle control such as automated driving and driving assistance. The “acquire/acquisition” in the present disclosure includes generation/detection by internal arithmetic based on data received from other apparatuses/sensors, and/or the like. This is because the functional layout in the system is changed as appropriate.

For example, the information acquisition unit F1 acquires detection results (i.e., sensing information) from various surrounding monitoring sensors 11 including the camera 11. The sensing information includes positions, moving speeds, categories and the like of other moving objects, natural and manmade features, obstructions all of which exist around the subject vehicle, and/or the like. The information acquisition unit F1 also acquires, from the vehicle condition sensor 12, a running speed, an acceleration, a yaw rate and an external illuminance of the subject vehicle, and/or the like. Further, the information acquisition unit F1 acquires own-vehicle location information from the locator 13. The information acquisition unit F1 acquires surrounding map information by referencing the map storage unit 14.

By cooperation with the radio communication equipment 15, the information acquisition unit F1 can acquire vehicle information transmitted from a vehicle ahead through the vehicle-to-vehicle communication. By cooperation with the radio communication equipment 15, the information acquisition unit F1 also acquires dynamic map data about a road section through which the subject vehicle is scheduled to pass within a predetermined time period. The dynamic map data as used herein includes traffic congestion information, merging vehicle information and/or the like.

The information acquisition unit F1 also acquires driver's operation against the automated driving system Sys, and/or the like based on a signal from the input apparatus 23. For example, the information acquisition unit F1 acquires an occupant instruction signal regarding the start and the end of the automated driving, from the input apparatus 23. The information acquisition unit F1 acquires the degree of eye opening, a direction of a line of sight and/or the like, as driver condition data from the occupant condition sensor 16.

Various items of information sequentially acquired by the information acquisition unit F1 are stored, for example, temporarily on a storage medium such as the memory 32 and/or the like, so that the information is used by the environment recognition unit F2, the mode control unit F3 and/or the like. The various items of information can be classified in categories and be stored in the memory 32. The various items of information can be sorted and stored such that, for example, the latest data is arranged at the top. The data can be discarded after the lapse of a predetermined time duration from the acquisition.

The environment recognition unit F2 recognizes the travel environment around the subject vehicle based on the own-vehicle location information, the surrounding object information and the map data acquired by the information acquisition unit F1. For example, the environment recognition unit F2 recognizes the travel environment around the subject vehicle through sensor fusion processing for fusing and combining detection results of a plurality of surrounding monitoring sensors 11 such as the camera 111, the millimeter-wave radar 112 and the like, with predetermined weights.

The travel environment includes a curvature of a road, the number of lanes, an own-vehicle lane number, weather, road surface conditions, whether or not to fall into a traffic congestion section, and/or the like. The own-vehicle lane number indicate what number lane the subject vehicle runs from a left or right road side. The own-vehicle lane number may be identified at the locator 13. The weather and the road surface conditions are able to be identified by combining the recognition results of the camera 111 with the weather information acquired by the information acquisition unit F1. The road structure may be identified using the static map data in addition to the recognition results of the camera 111.

The environment recognition unit F2 acquires information related to the road structure such as a curvature of the running path, based on at least one of the recognition results of the camera 111, the detection results of LiDAR, and the map data. The road structure includes: the presence or absence of a merge point; whether or not the subject vehicle running path corresponds to a main road at a merge point, a remaining distance to a merge point, a length of a side-by-side section, and/or the like. The environment recognition unit F2 also acquires positional coordinates of the merging start point Ps and the merging end point Pe and remaining distance to the merging start point Ps and the merging end point Pe, as detailed information regarding a merge point. The remaining distance to a merge point may be identified by recognizing an information sign included in the camera image. The presence of the merge point itself may also be detected based on the recognition of a traffic sign announcing a merge point/reduction in the number of lanes by the front camera. A function unit to acquire information regarding a merge point in the environment recognition unit F2 corresponds to a merge-point recognition unit F21.

The travel environment includes locations, categories, moving speeds of objects existing around the vehicle, and/or the like. Thus, the environment recognition unit F2 acquires information regarding a preceding vehicle, a merging vehicle and a subsequent vehicle, based on at least one of communications with external apparatus and the detection results of the surrounding monitoring sensor 11. The environment recognition unit F2 recognizing surrounding vehicles such as a preceding vehicle, a merging vehicle and a subsequent vehicle corresponds to a surrounding vehicle recognition unit F22. In another way, the environment recognition unit F2 acquires vehicle external environment information relating to ODD and/or the driver condition data.

The mode control unit F3 controls the operation mode of the automated driving ECU 30 based on various items of information acquired by the information acquisition unit F1. For example, the mode control unit F3 determines to shift to the automated driving mode when an instruction signal indicating start of automated driving is received from the input apparatus 23 under the occupant involved mode and conditions where the travel environment satisfies ODD. Then, a signal indicating a request to shift to the automated driving mode is output to the strategy unit F4. If the travel environment recognized by the environment recognition unit F2 has dissatisfied ODD during the automated driving mode, alternatively if it is predicted that the travel environment will dissatisfy within a predetermined time period, a shift to occupant involved mode is determined and the strategy unit F4 is notified of the determination.

Further, the mode control unit F3 determines to terminate the automated driving mode if an operation signal indicating termination of the automated driving mode from the input apparatus 23, and/or the override operation by the driver are detected during the automated driving mode. Then, the signal indicating the switchover to the manual driving is output to the strategy unit F4 and the control execution unit F5. The manual driving as used herein includes semimanual driving in which the driving assist function is operated. The override operation refers to occupant's operation of operation members such as the steering wheel/pedals. When the automated driving ECU 30 detects that the driver performs the override operation, the automated driving ECU 30 transfers at once the driving authority to the driver, and also uses voice output and/or the like to notify that switchover to the manual driving has been made. The operation mode to which a transition is made upon termination of the automated driving mode may be the full manual mode or may be the driving assist mode. A transition destination upon termination of the automated driving mode may be determined dynamically according to the circumstances, or alternatively may be preregistered by the driver.

The strategy unit F4 is configured to create a strategy for control contents to be performed as driving assistance or automated driving. For example, for application of the automated driving mode, the strategy unit F4 generates a travel strategy for autonomous travel based on the recognition results of the travel environment by the environment recognition unit F2. The travel strategy may be also called the control strategy. The travel strategy includes a running position, a target speed, a steering angle and/or the like on a time-of-day basis. That is, the travel strategy can include schedule information on acceleration and deceleration for speed adjustment on a calculated route, and schedule information on the amount of steering.

For example, the strategy unit F4 performs the route search processing to determine a scheduled travel route from a subject vehicle position to a destination as a medium-to-long term travel strategy. At that time, the strategy unit F4 calculates an estimated arrival time which is an estimated time of day of arrival at a destination. As a short term control strategy for performing the travel in line with the medium-to-long term travel strategy, the strategy unit F4 generates a travel strategy for making a lane change, a travel strategy for running on the lane-center, a travel strategy for following the preceding vehicle, a travel strategy for avoiding an obstruction, and the like. For example, as the short term control strategy, the strategy unit F4 generates a route for running on the center of the recognized own-vehicle lane as a travel strategy, and/or generates a route along behavior or travel track of the recognized preceding vehicle as a travel strategy. The strategy unit F4 creates a control strategy regarding the start/end of the automated driving based on the input signal from the mode control unit F3. The control strategy created by the strategy unit F4 is input to the control execution unit F5.

In addition to the control strategy related directly to vehicle travel, the strategy unit F4 formulates a strategy regarding processing for making notification to the occupant using a notification device such as the display 21 and/or the like. For example, the strategy unit 4 determines, according to the circumstances, timing for behavior notice indicating scheduled vehicle behavior such as a lane change, overtaking, deceleration and/or the like, timing for notification of a merging vehicle, and/or the like. Thus, the strategy unit F4 also creates a control strategy for the notification device relating to notification of a merging vehicle.

The control execution unit F5 generates a control command based on the control strategy formulated at the strategy unit F4, and then sequentially outputs the control commands to the travel actuator 19, the display 21 and/or the like. Based on the strategy of the strategy unit F4 and exterior environment, the control execution unit F5 also controls the on/off states of the turn signal, the headlight, the hazard light and/or the like, according to the travel strategy and/or the exterior environment.

The control execution unit F5 includes a notification processing unit F51 as a sub-function unit for making notification/suggestion to the occupant using the notification device such as the display 21 and/or the speaker 22. Various notifications/suggestions can be implemented by image display onto the display 21 and/or voice message output from the speaker 22. For example, at timing set at the strategy unit F4, the notification processing unit F51 uses at least one of the display 21 and the speaker 22 to notify of information describing a scheduled subject vehicle response to a merge point which will be reached within a predetermined time period. The response to the merge point means, for example, a temporary increase in inter-vehicle distance, deceleration, to give the right-of-way to a merging vehicle (i.e., cutting-in permission), and/or the like, as described below. The response to a merge point may translate to a response to a merging vehicle.

A response plan to a merging vehicle can be dynamically changed with reference to the number of merging vehicles merging between the subject vehicle and the preceding vehicle, the behavior of the preceding vehicle and the behavior of a subsequent vehicle. If the response plan to the merging vehicle is changed, the notification processing unit F51 preferably provides the changed response plan. A manner of notification about the merge point/merging vehicle may be determined at the strategy unit F4. The functional layout of the notification processing unit F51 and the strategy unit F4 is able to be changed as appropriate. The configuration including the strategy unit F4 and the control execution unit F5 corresponds to the configuration of executing the processing for adjusting the inter-vehicle distance based on the existence of a merging vehicle. A module including the strategy unit F4 and the control execution unit F5 corresponds to a vehicle control unit Fn.

### Response to Merge Point During Automated Driving

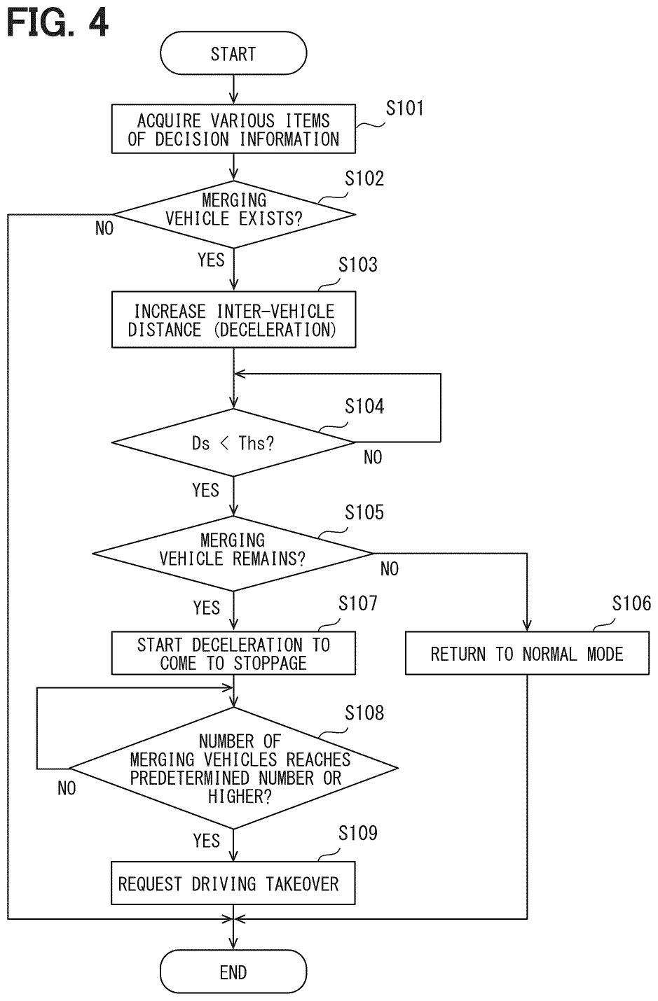

In this section, the merging vehicle response processing performed by the automated driving ECU 30 is described using the flowchart illustrated in FIG. 4. The merging vehicle response processing corresponds to processing for determining a control plan for a run within a predetermined distance from a merge point during the automated driving. The merging vehicle response processing can include processing for temporarily changing an automated driving parameter which is a control parameter in performing the automated driving, based on the existence of a merging vehicle. The automated driving parameters can include, for example, a target value of an inter-vehicle distance, a target value of running speed, an upper limit of an allowable acceleration, and/or the like.

The merging vehicle response processing can be executed based on the fact that, during the execution of the automated driving control, a remaining distance to a merge point reaches less than a predetermined preparation starting threshold value. For example, the merging vehicle response processing can be executed on condition that a remaining distance to a merge point is less than 500 meters. The preparation starting threshold value may be 250 meters, 750 meter or the like. The preparation starting threshold value may be dynamically determined according to the running speed, the category of the running path. The merging vehicle response processing may be executed on condition that the remaining time before the merge point is reached is less than a predetermined value. Stated another way, the preparation starting threshold value may be defined under the concept of the length of time until the subject vehicle reaches the merging start point Ps. For example, the preparation starting threshold value can be set at 10 seconds, 15 seconds or the like.

The merging vehicle response processing illustrated in FIG. 4 includes steps S101 to S109. All the various flowcharts provided in the present disclosure are merely illustrative, and the number of steps included in each flowchart and the execution order of processing are able to be altered as appropriate.

Initially, at step S101, the information acquisition unit F1 acquires various items of information used in subsequent processing. For example, information on surrounding vehicles, subject vehicle behavior, a remaining distance to a merge point, and/or the like are acquired. The information on surround vehicles includes an inter-vehicle distance from the preceding vehicle, a relative speed, and the like. The information on surrounding vehicles also includes positions and/or speeds of other vehicles except for the preceding vehicle, and/or the like.

At step S102, the surrounding vehicle recognition unit F22 determines, based on the information acquired in step S101, whether or not a merging vehicle exists. As information for making a decision about the presence or absence of a merging vehicle and/or the like, output from the surrounding monitoring sensor 11, received data from roadside units and/or the like, received data from a merging vehicle/preceding vehicle, and/or the like are adoptable as described above.

If a merging vehicle exists (S102, YES), the processor 31 executes step S103. On the other hand, if there is no merging vehicle (S102, NO), the flow is terminated. In the case where the flow is terminated, if passage through the merge point is not yet made at the time when a predetermined quiescent time is elapsed from the termination time point, the flow can be re-executed. The passage through a merge point corresponds to the case of passage through the merging end point Pe. The quiescent time can be set at, for example, 500 milliseconds, one second, two seconds, and the like.

The merging vehicle of which the presence or absence is determined in step S102 is preferably a vehicle that produces a moment in time when a distance from the subject vehicle reaches less than a predetermined value at a merge point, in other words, a vehicle that may possibly merge between the subject vehicle and the preceding vehicle. Thus, step S102 can be a step in which it is determined whether or not there exists the merging vehicle to which attention should be paid. Considering a relative speed and/or a relative position of the merging vehicle, the processor 31 may remove a vehicle which will merge behind the subject vehicle without doubt, from the range of determination made in S102. The vehicle which will merge behind the subject vehicle without doubt is, for example, a vehicle predicted to locate a predetermined distance or more behind the subject vehicle at a time point when the subject vehicle reaches the merging start point Ps.

Considering a relative speed and/or a relative position, the processor 31 may remove the merging vehicle which will merge in front of the preceding vehicle without doubt, from the range of determination made in S102. The vehicle which will merge in front of the preceding vehicle without doubt is, for example, a vehicle that is located corresponding to a position a predetermined distance or more in front of the preceding vehicle on a merge road, and also that runs at a faster speed of a predetermined value or higher than the preceding vehicle runs. During traffic congestion, depending on local customs used by the automated driving system Sys, all merging vehicles located ahead of the merging start point Ps may be interpreted as merging vehicles to which attention should be paid.

At step S103, control is executed for temporarily increasing the inter-vehicle distance from the preceding vehicle by a predetermined amount from a point an adjustment distance short of the merge point. The adjustment distance is the same as, for example, the preparation starting threshold value, but is set shorter than the preparation starting threshold value. The adjustment distance may be adjusted according to the running speed. The adjustment distance may be set, for example, at 500 meters or 400 meters during running, for example, at the speed of 100 km/h.

The control to increase temporarily the inter-vehicle distance from the preceding vehicle by a predetermined amount may be, for example, deceleration control to decrease the running speed by a predetermined amount from a current value. The deceleration control can be implemented by decreasing a set value of a target speed in the automated driving from an original value by a predetermined amount. The normal target speed which is an original target value for the running speed refers to a set value applied in the case of running in a section a predetermined distance or more away from the merge point, such as, e.g., a value set by a driver, a design value, a value determined according to the speed of a preceding vehicle, or the like.

The amount of deceleration as a merging vehicle response may be a constant amount such as 3 km/h, 5 km/h, 10 km/h or the like. The amount of deceleration may also be a value dynamically determined according to the normal target speed, such as 5% or 10% of the normal target speed or the like. The deceleration control as a merging vehicle response may be to decelerate to a preset degeneracy speed. The degeneracy speed only has to be set with reference to road category. For example, the degeneration speed may be set at 60 km/h on a freeway, 40 km/h on an ordinary road, and/or the like. In the present disclosure, the target speed reduced as the merging vehicle response is also referred to as a temporary target speed. By decreasing the target value of the running speed by a predetermined amount, a natural increase in inter-vehicle distance from the preceding vehicle results. A target value of running speed in the automated driving is set at a value lower than the normal target speed by a predetermined amount, and thus such setting corresponds to an example of front space extension control. The front space as used in the present disclosure is the inter-vehicle distance between the subject vehicle and a preceding vehicle. The front space may translate to a front inter-vehicle distance.

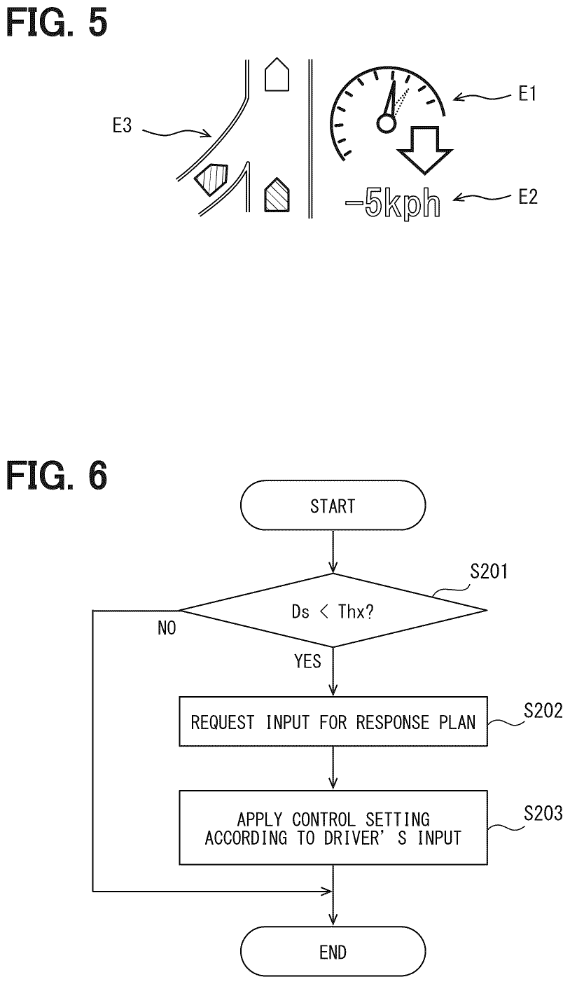

If it is determined that the vehicle speed is reduced with increasing proximity to the merge point, the processor 31 may perform, in conjunction with the vehicle-mounted HMI 20, the processing for notifying the driver that the vehicle speed will be reduced. For example, the notification processing unit F51 causes the display 21 to display a deceleration notification image illustrated in FIG. 5. The notification about deceleration may be made by outing a predetermined voice message from the speaker 22. The timing to make notification about a speed reduction may be timing for the automated driving ECU 30 for starting actually deceleration or may be one second or three seconds prior to the start of deceleration, and/or the like. For example, the notification processing unit F51 may display a deceleration notification image as notice from a predetermined time period before the start of deceleration. The deceleration notification image may include a deceleration icon E1 indicating deceleration, an element image E2 indicating the amount of deceleration, a merging vehicle icon E3 indicating the existence of a merge point/merging vehicle, and/or the like. It is to be understood that the deceleration notification image may not include the merging vehicle icon E3 or may include only the deceleration icon E1.

If supplementary information on the amount of deceleration and/or the like is included in the deceleration notification image, then the effect of improving the driver's acceptance/understanding of the deceleration can be expected. As another aspect, the notification processing unit F51 may make an inquiry to the driver as to whether or not the deceleration is permitted, prior to the start of deceleration. In this case, where the driver permits the reduction in vehicle speed, it may be determined that the deceleration is performed. A reply of the driver to the inquiry can be acquired through the input apparatus 23. Even after a lapse of a predetermined response waiting time period from when the inquiry is made as to whether or not the deceleration is permitted, if there is no input (response) from the driver, the processor 31 may automatically determine that the deceleration is permitted. Understandably, even after a lapse of a predetermined response waiting time period from when the inquiry is made as to whether or not the deceleration is permitted, if there is no input (response) from the driver, it may also be automatically determined that the deceleration is disallowed.

The control to increase temporarily the inter-vehicle distance from the preceding vehicle by a predetermined amount may also be the processing for increasing a set value of the inter-vehicle distance from the preceding vehicle, from an original target value by a predetermined amount, with the set value being a control target in the automated driving. The normal inter-vehicle distance which is an original target value for the inter-vehicle distance refers to a set value applied in the case of running in a section a predetermined distance or more away from the merge point, such as, e.g., a value set by a driver, a design value, a value determined according to the speed of a preceding vehicle, or the like.

The amount of extension in inter-vehicle distance as a merging vehicle response may be a constant amount such as 100 meters, 50 meters, or the like. The amount of extension may also be a value dynamically determined according to the normal interval-vehicle distance, such as 50%, 75% or 100% of the normal inter-vehicle distance, or the like. In the disclosure, the inter-vehicle distance extended as the merging vehicle response is also referred to as a temporary inter-vehicle distance. The target value of the inter-vehicle distance in the automated driving is changed to a value higher than the normal inter-vehicle distance, and this change corresponds to another example of the front space extension control.

Because a value depending on whether or not traffic congestion is occurring is applied to the normal inter-vehicle distance, a value depending on whether or not traffic congestion is occurring is also applied to the temporary inter-vehicle distance. In the case where the normal inter-vehicle distance during traffic congestion is 5 meters, the temporary inter-vehicle distance during traffic congestion is set at 10 meters, 15 meters or the like. The amount of extension in inter-vehicle distance during traffic may be dynamically determined according to the size or category of the other vehicle which is about to merge. In the case where the merging vehicle is a passenger vehicle, the amount of extension is set at 5 meters or 10 meters. On the other hand, in the case where the merging vehicle is a truck or a bus, the amount of extension suitably used is 15 meters, 20 meters or the like. The amount of extension may be determined according to the size of the merging vehicle which is detected by the surrounding monitoring sensor 11. By increasing the target value of the inter-vehicle distance by a predetermined amount, a natural increase in inter-vehicle distance from the preceding vehicle in real space results. The inter-vehicle distance may be represented by a time distance. For example, in the case where the normal inter-vehicle distance is set at two seconds, the temporary inter-vehicle distance can be set at three seconds or the like. The time distance from the preceding vehicle corresponds to a length of time until the subject vehicle passes through a point which has been passed through by the preceding vehicle.

At step S103, control is performed to pre-extend the inter-vehicle distance with increasing proximity to the merge point. As a result of the control, the merging vehicle is made easy to merge between the preceding vehicle and the subject vehicle. Consequently, the risk of the merging vehicle approaching the subject vehicle from the side is able to be reduced. Consequently, the risk of an encounter with aggressive cutting-in and/or the like may be reduced. With the above configuration, a reduction of the risk of requirement to make a highly advanced judgement for the cut-in vehicle may be achieved, and also a higher degree of safety may be achieved.

At step S104, the processor 31 determines whether or not the merge-start remaining distance Ds recognized at the environment recognition unit F2 is less than a predetermined reconfirmation threshold value Ths. The reconfirmation threshold value Ths is set at value lower than the preparation starting threshold value, such as e.g., 100 meters, 200 meters or the like. The reconfirmation threshold value Ths is set at a value that enables a stoppage/sub-stoppage at the merging start point Ps during deceleration with a predetermined acceleration, such as of −1.0 m/s\hat{ }2, −1.5 m/s\hat{ }2, or the like. If a deceleration to come to a stoppage at the emerging start point Ps is α, and a current speed is Vo, Ths=VO\hat{ }2/(2α). Vo can be a speed or a temporary target speed for maintaining the temporary inter-vehicle distance. The sub-stoppage condition refers to an immediately stoppable condition (i.e., slowdown condition) in which a speed is, for example, below 5 km/h. A target stoppage position may be a point located a predetermined distance (e.g., 5 meters) short of the merging start point Ps. If the merge-start remaining distance Ds reaches below the predetermined reconfirmation threshold value Ths, the processor 31 executes step S105. On the other hand, if the merge-start remaining distance Ds is equal to or higher than the predetermined reconfirmation threshold value Ths, the determination in step S105 is made at intervals of a predetermined time period, such as, e.g., 500 milliseconds, one second or the like.

At step S105, the environment recognition unit F2 determines, based on similar information to that in step S102, whether or not there remains the merging vehicle. The merging vehicle to be determined about its presence or absence in step S105 as in the case of step S102 may be limited to the vehicle to which attention should be paid. During traffic congestion, all vehicles existing in the merge road or all vehicles existing within a predetermined distance from the merging end point Pe in the merge road may be interpreted as vehicles to which attention should be paid.

If it is determined in step S105 that there remains the merging vehicle, the processor 31 executes step S107. On the other hand, if it is determined that there is no merging vehicle, the processor 31 executes step S106.

At step S106, the strategy unit F4 restores a control parameter changed through the merging vehicle response processing, to an original value. For example, in the case where the running speed is reduced, a target speed used in subsequent control strategies is switched from the temporary target speed to the normal target speed. When the inter-vehicle distance has been extended, a target inter-vehicle distance used in subsequent control strategies is switched from the temporary inter-vehicle distance to the normal inter-vehicle distance. In the present disclosure, the condition in which control setting for extending the inter-vehicle distance as a reaction to a merging vehicle is applied is referred to as temporary mode. On the other hand, the condition in which control setting for extending the inter-vehicle distance as a reaction to a merging vehicle is not applied is referred to as normal mode. The normal mode corresponds to the automated driving mode in the case where there is a predetermined distance or more away from the merge point. The temporary mode corresponds to the automated driving mode in the case of travel within a predetermined distance from the merge point or the case where the merging vehicle exists diagonally in front of the subject vehicle.

At step S107, the processor 31 starts the deceleration control to come to a stoppage at a predetermined distance short of the merging start point Ps, in order to prevent the subject vehicle from moving beyond the merging start point Ps. For example, the strategy unit F4 sets a point located two meters short of the merging start point Ps as a tentative scheduled stop position, and creates a speed adjustment schedule for stopping at the scheduled stop position in question. The control execution unit F5 starts the deceleration control according to the schedule in question generated by the strategy unit F4. As long as the subject vehicle is located short of the merging start point Ps, the merging vehicle is never to approach the subject vehicle from the side of the subject vehicle. By the deceleration of the subject vehicle for coming to a stoppage, a space is created between the preceding vehicle and the subject vehicle to allow the merging vehicle to merge in front of the subject vehicle. By execution of step S107, the risk of the merging vehicle approaching the subject vehicle from the side of the subject vehicle is able to be reduced. If it is determined to start the deceleration control to come to a stop at the scheduled stop position, the processor 31 may notify the driver of a temporary halt to be made at the merge point through the notification device such as the display 21 and/or the like.

Step S108 is a step for determining whether or not the number of merging vehicles merging between the subject vehicle and the preceding vehicle reaches equal to or higher than a predetermined permissible merge number. The preceding vehicle as used herein is a preceding vehicle that has been recognized before the merging vehicle merges in front of the subject vehicle, and identified, for example, at the time when the merge-start remaining distance Ds reaches the preparation starting threshold value or the reconfirmation threshold value Ths. Actual leading vehicles can change every time a merging vehicle merges in front of the subject vehicle. The merging vehicle having merged in front of the subject vehicle can result in a new preceding vehicle. For distinction from a preceding vehicle replaced by the merge, the preceding vehicle identified at the time when the merge-start remaining distance Ds reaches the preparation starting threshold value or the reconfirmation threshold value Ths is also described as an initial preceding vehicle in the present disclosure. The automated driving ECU 30 determines, from the detection result of the surrounding monitoring sensor 11, the number of merging vehicles which is the number of vehicles merging between the initial preceding vehicle and the subject vehicle. For example, the automated driving ECU 30 may determine the number of merging vehicles based on the number of times the preceding vehicles change after step S101 or step S104. Whether or not the preceding vehicles change can be dependent on a quick change in inter-vehicle distance from the preceding vehicle, a change in color of the preceding vehicle, and/or a lane change/cutting-in of a vehicle ahead. The permissible merge number can be set, for example, at 1, 2, 3, 4 or the like. A concrete value of the permissible merge number may be configured in a registrable/changeable manner by predetermined setting of the driver.

In the case where the number of merging vehicles that merge between the subject vehicle and the preceding vehicle (i.e., the number of merging vehicles) reaches equal to or higher than the permissible merge number, the processor 31 executes step S109. Step S109 is a step for executing a driving takeover request to ask the driver to take over driving operation. The driving takeover request includes processing for outputting a message of asking the driver to perform driving operation, from at least one of the display 21 and the speaker 22. In step S109, the processor 31 may cause the outward display device 18 to display an entry prohibition image, instead of/together with the driving takeover request. In the case where the number of merging vehicles is less than the permissible merge number, the outward display device 18 may be caused to display the entry permission image. The communication with another vehicle about the permission/prohibition of merge may be made through the vehicle-to-vehicle communications.

### Problems to be Resolved by Above Configuration

The configuration in the disclosure of JP-6817334B2 is premised on the conditions before automated driving is started, that is, during manual driving. Japanese JP-6817334B2 has conducted no study regarding whether the automated driving is discontinued or continued depending on the presence or absence of a merging vehicle during the automated driving.

An example of conceivable configurations of the automated travel device is a configuration in which the automated driving is ended/temporary halted when existence of a merging vehicle is detected during the automated driving. This is because if a merging vehicle attempts to merge forcibly (aggressively) in front of the subject vehicle, it can be difficult for the automated travel device to make a determination on appropriate response.

However, if the automated driving is discontinued every time a merging vehicle is detected, then the duration of running by the automated driving will be decreased. In association with this, a frequent occurrence of a condition requiring the surrounding monitoring/driving operation by the driver results. In consequence of this, the convenience of automated driving can be compromised.

JP-6817334B2 discloses the configuration in which the start of automated driving is permitted when there is no merging vehicle or when the lead time to collision with a merging vehicle is equal to or higher than a predetermined value, but all of them is assumed as accidental cases. In JP-6817334B2, there is no technological idea for creating consciously the above-described situations in order to enhance the continuity of automated driving.

### Advantageous Effects of the Embodiments

With the configuration according to the above-described embodiments, when the automated driving ECU 30 detects existence of a merging vehicle in front of the subject vehicle, the automated driving ECU 30 extends an inter-vehicle distance from a preceding vehicle prior to arrival at a merge point. Therefore, room (space) to allow a merging vehicle to merge smoothly into a main road is created in front of the subject vehicle. Thus, the merging vehicle is able to merge while ensuring a sufficient inter-vehicle distance from the subject vehicle, so that it is possible to reduce, in advance, the number of merging vehicles itself which can exert influence on running of the subject vehicle. It is also possible to inhibit an event of a vehicle intending to merge forcibly in front of or behind the subject vehicle from a merging road. As a result, it is possible to reduce the risk of asking the driver to take over driving because a system limit is reached, and/or of performing an emergency stop (i.e., MRM (Minimal Risk Maneuver)).

In the case where the merging vehicle still exists even after the remaining distance to the merging start point Ps reaches less than a predetermined value, deceleration is started to allow the subject vehicle to come to a temporary halt before the merging start point Ps. With the configuration concerned, the remaining merging vehicle is also able to merge smoothly into a main road, so that the risk of the merging vehicle excessively approaching the subject vehicle may be reduced.

Further, the automated driving ECU 30 makes a driving takeover request when the number of merging vehicles merging in front of the subject vehicle reaches equal to or higher than a predetermined value. With the configuration concerned, excessive permission for the merging vehicle to merge can cause a risk of offensive to the driver of the subject vehicle and/or the driver of a subsequent vehicle, but the risk is able to be reduced.

For example, where the subject vehicle reaches the scheduled stop position or where the remaining distance to the scheduled stop position reaches equal to or less than a predetermined update threshold value, after step S107, the processor 31 may reset the scheduled stop position to a position located in a predetermined distance ahead of the current scheduled stop position. In this case, the processor 31 restarts the automated travel toward the scheduled stop position reset. The update threshold value may be updated to be 3 meters, 10 meters or the like. The update threshold value may be 0 meters. The scheduled stop position to be reset may be set at a point 5 meters or 10 meters ahead of the current set position (toward the traveling direction). A set interval for the scheduled stop position is able to be changed as appropriate. A running speed for running toward the scheduled stop position is preferably maintained at a speed enabling an immediately stoppage, such as 5 km/h or the like. The above-described control may be, as a whole, control to move the subject vehicle in such a way as to run slow without complete stoppage, or may be control to repeat stoppage and traveling by a predetermined amount. In addition to above, the processor 31 may change the display on the outward display device 18. For example, the entry permission image can be displayed during stop, whereas the entry prohibition image can be displayed during traveling. The traveling from a stoppage may be performed every time a vehicle merges. With the configuration in question, it is possible to reduce the risk of a plurality of vehicles merging successively in front of the subject vehicle. In association with this, the risk of offensive to the drivers of the subject vehicle and a subsequent vehicle may be reduced. Thus, the configuration of the disclosure can provide improved convenience of automated driving.

A start from a stop during the automated driving can require the driver's operation. In the case where a stop is made before the merging start point Ps/merging end point Pe, the processer 31 may restart running through the automated driving in response to the switch operation or depression of the accelerator pedal by the driver. With such a configuration, the automated travel is able to be restarted with a single action of the driver, so that the convenience can be improved. The restart of the automated travel may be performed provided that it has been confirmed that the driver is looking ahead of his/her vehicle, based on the input signal of the occupant condition sensor 16.

Depending on whether or not the travel environment is traffic congestion, the processor 31 may automatically determine whether or not the deceleration control is executed for coming to a stop before the merging start point Ps. If no traffic congestion occurs, the deceleration control to come to a stop before the merging start point Ps can oppositely cause disruptions in traffic flow. From such concern, the processor 31 may be configured such that, if it is determined that the travel environment is not in traffic congestion, the deceleration control to come to the stop is not performed. The scene in which the deceleration control is executed for coming to a stop before the merging start point may be limited to when it is determined that the travel environment is traffic congestion.

When the existence of a merging vehicle is detected at the time when the merge-start remaining distance Ds has reached the preparation starting threshold value or the reconfirmation threshold value Ths, the processor 31 may provide image display or voice output indicating the possibility of making a stop before a merge point. With such a configuration, the driver is able to recognize in advance the possibility of stop for a reaction to a merging vehicle. In association with this, measures such as override operation and/or the like are able to be voluntarily considered.

The operation of the automated driving ECU 30 where an initial preceding vehicle exists has been described. However, it should be understood that an initial preceding vehicle cannot exist in actual environment. No existence of a preceding vehicle corresponds to, for example, the case where there is no another vehicle running in the same lane within 300 meters ahead of the subject vehicle. In the case where a merging vehicle exists and also no preceding vehicle exists, the processor 31 may determine whether a current speed is maintained or reduced according to the relative position and the relative speed of the merging vehicle to the subject vehicle. For example, if it is apparent, based on the relative position and the relative speed of the merging vehicle, that the merging vehicle will merge behind the subject vehicle, the current speed is maintained. At this time, the processor 31 may cause the outward display device 18 to display an image for a request to merge behind the subject vehicle. If, based on the relative position and the relative speed of the merging vehicle, there is a possibility that the subject vehicle and a merging vehicle run side by side around the merging start point, or alternatively, if there is a possibility that the merging vehicle merges in front of the subject vehicle, the control to decelerate by a predetermined amount may be started. At this time, the processor 31 may cause the outward display device 18 to display an image showing to give the right-of-way to the merging vehicle.

The configuration for executing the processing for extending the inter-vehicle distance on condition that the merging vehicle exists (S102, YES) has been described. However, it is sometimes difficult that the presence or absence of the merging vehicle is recognized from a point away from the merging start point Ps by use of the surrounding monitoring sensor 11. Therefore, the processor 31 may start the control to extend temporarily the inter-vehicle distance based on the fact that the merge-start remaining distance Ds reaches less than the predetermined value, without determining whether or not the merging vehicle exists.

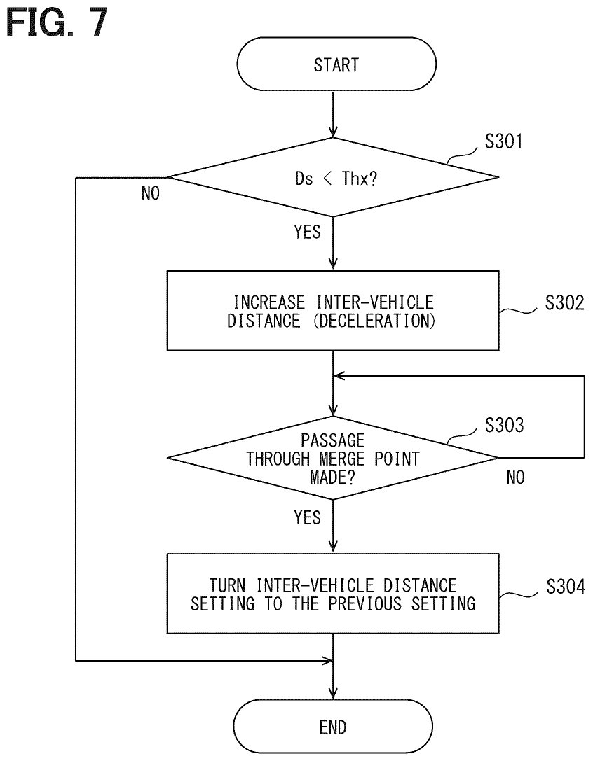

FIG. 7 is a flowchart illustrating an example operation of the processor 31 to start the front space extension control based on the fact that the merge-start remaining distance Ds reaches less than the predetermined value. With the example control illustrated in FIG. 7, in an area in which it is very likely that the merging vehicle exists, the inter-vehicle distance from the preceding vehicle may be extended even without arithmetic processing for recognizing the merging vehicle. As a result of this, similar advantageous effects in the above-described embodiment can be successfully achieved. Step S301 shown in FIG. 7 is a step for determining whether or not the merge-start remaining distance Ds with respect to a next merge point reaches less than a predetermined confirmation threshold value Thx. Step S302 is a step for starting the front space extension control. Step S303 is a step for determining whether or not a passage through the merge point is made. Based on the passage through the merge point, the processor 31 performs, as step S304, the control to restore a target value for the inter-vehicle distance or a target value for the running speed to an original value according to driver's setting and/or the like.

In the processor 31, the amount of deceleration/the amount of inter-vehicle distance extension for a case where the existence of the merging vehicle is unconfirmed may be smaller than the amount of deceleration/the amount of inter-vehicle distance extension for a case where the existence of the merging vehicle is confirmed. For example, by the processor 31, the amount of inter-vehicle distance extension for the merging vehicle confirmed is set at 150 meters. On the other hand, even when the merge-start remaining distance Ds is less than the preparation starting threshold value, the surrounding monitoring sensor 11 does not confirm whether or not the merging vehicle exists. For such a case, the amount of inter-vehicle distance extension may be the order of 50 meters or 100 meters. In this manner, the amount of deceleration/the amount of inter-vehicle distance extension may be adjusted according to the conditions of recognition of the merging vehicle at the surrounding monitoring sensor 11. According to the present disclosure, it is possible to reduce the risk of excessive extension of the inter-vehicle distance/excessive deceleration despite the absence of the merging vehicle. If the merging vehicle exists actually, it also is possible to approximate smoothly the vehicle state to a control target state for the existence of a merging vehicle.

Based on the fact that the automated driving is started or the fact that the remaining distance to the merge point reaches equal to or less than the predetermined value, the processor 31 may perform response plan confirmation processing which is processing for making an inquiry to the driver about a response plan of the system to the merging vehicle. The response plan confirmation processing includes displaying a response plane selection screen on the display 21, by way of example. The response plane selection screen is for making a selection between a reduction in speed for continuation of the automated driving and temporary driving of the driver, as a system response when the merging vehicle is detected. The response plan confirmation processing also includes acquiring a selection result of the driver based on a signal from the input apparatus 23 during the display of the response plan selection screen.

Even after a lapse of a predetermined input waiting time period from when the response plan selection screen is displayed, if the driver input is not acquired, then this may be interpreted as the selection of a predetermined base plan. The base plan is, for example, a reduction in speed for continuation of the automated driving. The response plan selection processing may be configured to allow the driver to select from among detailed options for the reduction in speed for continuation of the automated driving, the detailed options including the permissible merge number, and/or whether or not stoppage finally made near the merging start point Ps is permitted. The response plan confirmation processing as described above corresponds to processing for a request to select from between stopping before the merge point and a takeover of driving operation, where the merging vehicle exists.

FIG. 6 is a flowchart for explaining the response plan confirmation processing which is a concrete form of the above technological idea. FIG. 6 can be executed at predetermined intervals during the automated driving, by way of example. The control can be performed to prevent the response plan confirmation processing from being performed several times on the same merge point. The response plan confirmation processing can be executed for each merge point and/or each trip. The trip as used herein refers to a series of travels from when the travel power source is turned on until it is turned off.

The response plan confirmation processing illustrated in FIG. 6 includes steps S201 to S203. The processing flow in question is able to be performed in parallel with, in combination with or in substitution for the aforementioned various steps of processing.

Initially, step S201 is a step for determining whether or not the merge-start remaining distance Ds with respect to a next merge point reaches less than a predetermined confirmation threshold value Thx. The confirmation threshold value Thx is set to a length that allows a time period remaining until arrival at the merging start point Ps to become from 20 seconds to 30 seconds. The confirmation threshold value Thx may be dynamically determined according to the current vehicle speed or normal target speed. In the case where the merge-start remaining distance Ds for a merge point on which the response plan confirmation processing is not performed reaches less than the predetermined confirmation threshold value Thx, the processor 31 executes step S202. The confirmation threshold value Thx may be the same as the aforementioned preparation starting threshold value.

Step S202 is a step for, in conjunction with the vehicle-mounted HMI 20, making a request to input a response plan. For example, step S202 can include displaying a response plan selection screen. Step S203 is a step for applying control setting corresponding to a response plan selected by the driver. If the response plan confirmation processing is executed for each merge point, then inconvenience can be caused to the driver. From such concern, the processor 31 may be configured such that, where one cycle of the response plan confirmation processing is performed, the response plan which has been input in the cycle during the pertinent trip is applied to another merge point.

In another way, where the merging vehicle still exists in a section corresponding to an area diagonally in front of the subject vehicle on the merge road even after the merge-end remaining distance De reaches less than a predetermined value (e.g., 10 meters), the processor 31 may be configured to make a temporary halt in a predetermined distance short of the merging end point Pe. For example, in the above-described case, the processor 31 may cause the subject vehicle to come to a temporary halt 5 meters short of the merging end point Pe. A temporary halt position may be adjusted according to the size of the merging vehicle existing diagonally in front of the subject vehicle. By a temporary halt made before the merging end point pe, the merging vehicle existing at the ending end of the merge road is able to merge smoothly into the main road.

The merging vehicle response processing as described above may be executed on condition that the own-vehicle lane is a merged lane. The merged lane as used herein refers to one of the lanes included in the main road, the one lane being located closest to the merge road, in other words, to the lane connecting with the merge road. In the case where the own-vehicle lane is not the merged lane, the risk of being affected by the merging vehicle is small as compared with where the own-vehicle lane is the merged lane. The processor 31 may be configured such that the control to extend the inter-vehicle distance is not performed where the own-vehicle lane is not the merged lane.

The pattern in which the processor 31 performs the front space extension control when the merging vehicle is detected has been described, whereas the processor 31 may perform front space shortening control based on the merging vehicle is detected. The front space shortening control is control to shorten temporarily the inter-vehicle distance between the subject vehicle and the preceding vehicle. In the front space shortening control, for example, a target value of the running speed in the automated driving may be set to a value larger by a predetermined amount than the normal target speed. In the front space shortening control, a target value of the inter-vehicle distance in the automated driving may be changed to a value smaller by a predetermined amount than the normal inter-vehicle distance.

If the inter-vehicle distance between the subject vehicle and the preceding vehicle (i.e., front space) is lessened, then the merging vehicle is not easy to merge in front of the subject vehicle. If the front space is lessened, then the rearward space which is the inter-vehicle space between the subject vehicle and the subsequent vehicle extends naturally. In consequence, the possibility is increased that the merging vehicle will merge into the main road behind the subject vehicle. With the configuration in which the processor 31 performs the front shortening control as a response to the merging vehicle, the effect of prompting the merging vehicle to merge behind the subject vehicle may be expected. The front space shortening control may be interpreted as the control to extend the rearward space in order to prompt the merging vehicle to enter the main road behind the subject vehicle. The front space shortening control may translate to rearward space extension control. The rearward space is able to translate to a rear inter-vehicle distance.

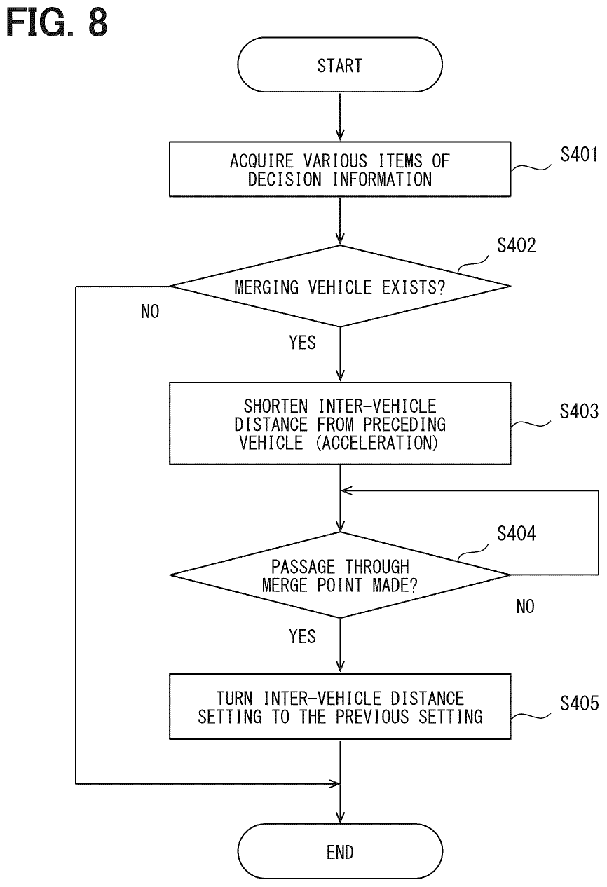

FIG. 8 is a flowchart corresponding to the case of performing the front space shortening control, instead of the front space extension control. FIG. 8 includes, for example, steps S401 to S405. Steps S401 to S402 are the same as steps S101 to S102. Step S403 is a step for performing when the merging vehicle exists. The processor 31 executes the front space shortening control as step S403. The processor 31 may start the front space shortening control as soon as the merging vehicle detects. The processor 31 may also start the front space shortening control from a point located a predetermined distance short of the merging start point Ps. The predetermined distance as used herein may be a constant value such as e.g., 200 meters or the like, or alternatively, may be a value obtained by multiplying the running speed by a predetermined conversion factor.

Step S404 is a step for determining whether or not a passage through the merge point is made. Based on the passage through the merge point, the processor 31 terminates the front space shortening control as step S405. Specifically, the processor 31 restores a target value for the inter-vehicle distance or a target value for the running speed to an original value according to driver's setting and/or the like.

Regardless of the presence or absence of the merging vehicle, based on the fact that the merge-start remaining distance Ds reaches less than the predetermined value, the processor 31 may start the front space shortening control. The processor 31 may select whether to perform the front space extension control or to perform the front space shortening control based on the detected number, positions, relative speeds and vehicle type of merging vehicles. For example, the processor 31 may adopt the front space extension control where two merging vehicles or more are detected, whereas the processor 31 may adopt the front space shortening control where only one merging vehicle is detected. From the relationship of the relative speed between the detected merging vehicle and the subject vehicle and the current locations of them, the processor 31 may determine whether or not the merging vehicle reaches earlier the merging end point than the subject vehicle, and then based on the result of the determination, the processor 31 may change the response plan. For example, the processor 31 may select the front space extension control where the merging vehicle is predicted to reach earlier the merging end point than the subject vehicle, whereas the processor 31 may select the front space shortening control where the subject vehicle is predicted to reach earlier the merging end point than the merging vehicle.

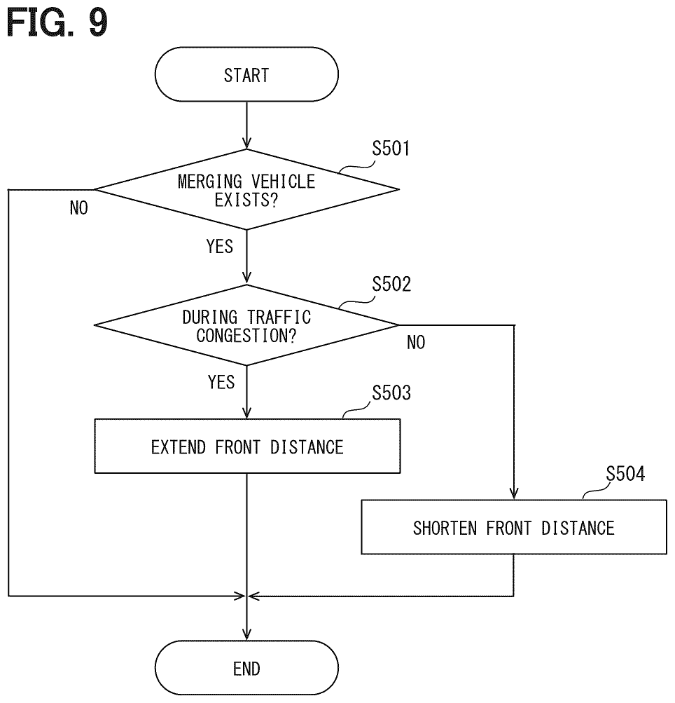

Depending on whether or not traffic congestion is taking place, the processor 31 may decide a response plane when the merging vehicle is detected during the automated driving. For example, as illustrated in FIG. 9, the processor 31 may perform the front space extension control based on the detection of the merging vehicle where traffic congestion is caused around the subject vehicle. On the other hand, the processor 31 may perform the front space shortening control where no traffic congestion is caused around the subject vehicle Step S501 shown in FIG. 9 is a step for determining whether or not the merging vehicle exists. Step S502 is a step for determining whether or not surrounding environment is traffic congestion where the merging vehicle is detected. Step S503 is a step for executing the front space extension control based on the detection of the merging vehicle during traffic congestion. Step S504 corresponds to a step for executing the front space shortening control based on the detection of the merging vehicle during non-traffic congestion.

The behavior of the merging vehicle can differ depending on whether traffic congestion is occurring or traffic flow is smooth. For example, during traffic congestion, the possibility can be increased that the merging vehicle will cut in slowly and forcibly (aggressively). On the other hand, under conditions where the traffic flow is smooth, because of appropriate spaces existing in front of and behind the subject vehicle, the possibility that the merging vehicle will forcibly merge in front of the subject vehicle is relatively low. The above-described configuration has been created based on design ideas as described above. With the above configuration, the system response to the merging vehicle during traffic congestion can become more appropriate. The risk of the driver being stressed may be reduced by setting to give priority to the front space shortening control during travels. The front space extension control in traffic congestion of a level at which the subject vehicle repeats stopping and starting may be control to maintain the stopped state of the subject vehicle until a predetermined time period has elapsed, until the front inter-vehicle distance reaches a predetermined value, or until a single merging vehicle merges, even if the preceding vehicle moves on. The processor 31 may be configured to execute the front space shortening control on condition that no traffic congestion is occurring.

The processor 31 may perform the front space extension control based on an instruction of the driver or pre-set data even when no traffic congestion is occurring. The processor 31 may be configured such that neither the front space extension control or the front space shortening control is performed in relation to the detection of the merging vehicle, where no traffic congestion is occurring. In short, step S504 may be omitted. The control sequence shown in FIG. 9 is an example of setting to perform the front space shortening control on condition that no traffic congestion is occurring.

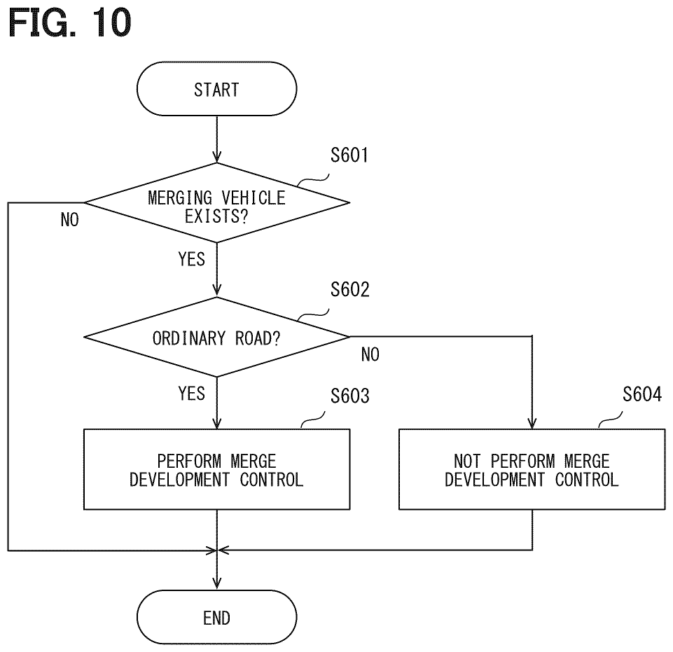

The frequency of occurrence of the merging vehicle and/or the behavior of the merging vehicle can differ depending on the road category such as an ordinary road or a limited-access road. For example, in an ordinary road, the merging vehicle is expected to merge into the main road after coming to a temporary halt. On the other hand, in a freeway, except under traffic congestion, the merging vehicle intends to merge into the main road with a certain speed or more. It is conceivable that the driver may desire a different system response to the merging vehicle depending on the road category. From such the circumstances, the processor 31 may change the response plan for a case where the merging vehicle is detected, depending on the category of the subject vehicle running path. For example, as illustrated in FIG. 10, the processor 31 may be configured such that predetermined merge development control is performed when the merging vehicle is detected during automated travel on the ordinary road, whereas the merge development control is not performed when the merging vehicle is detected during travel on the limited-access road.

The merge development control as used herein is control to prompt/assist the merging vehicle to merge in front of the subject vehicle. The merge development control may be the aforementioned front space extension control. The merge development control may be turning-off of the headlight, a temporary halt, and/or the like. In case of during travel with the headlight turned on, the merge development control may be control to turn momentarily on the headlight (i.e., flashing). The merge development control may be processing for displaying an entry permission image on the outward display device 18. The merge development control may be control to output light and/or sound in a predetermined pattern toward the outside of vehicle in order to communicate the permission to merge in front of the subject vehicle. The merge development control may be processing for transmitting a message of merging permission via the vehicle-to-vehicle communication. The merge development control may be interpreted as control to devolve positively the right to travel ahead of the subject vehicle to the merging vehicle, or alternatively control to give previously/voluntarily way to merging vehicle on the road ahead of the subject vehicle even without any explicit action on merge from the merging vehicle.

Step S601 shown in FIG. 10 is a step for determining whether or not the merging vehicle exists. Step S602 is a step for, if the merging vehicle is detected, determining whether or not the vehicle is travelling on the ordinary road. Step S603 is a step for executing the merge development control, based on the fact that the merging vehicle is detected during travelling on the ordinary road. Step S604 is a step for canceling the execution of the merge development control, if the vehicle is travelling on the limited-access road when the merging vehicle is detected.

Step S604 may be a step for performing cutting-in prevention control although the merge development control is not performed. The cutting-in prevention control may be interpreted as control to prompt the merging vehicle to merge not only in front of the subject vehicle but also behind the subject vehicle. The cutting-in prevention control may also be called rear merge navigation control. The processor 31 may perform the aforementioned front space shortening control as the cutting-in prevention control. The cutting-in prevention control may be to display the entry prohibition image on the outward display device 18, and/or to transmit a message of asking to merge behind the subject vehicle via the vehicle-to-vehicle communication. The cutting-in prevention control may be processing for displaying the entry prohibition image on the outward display device 18. The cutting-in prevention control may be control to output light and/or sound in a predetermined pattern of asking to merge behind the subject vehicle, toward the outside of vehicle. Even under execution of the cutting-in prevention control, if the risk of contact between the merging vehicle and the subject vehicle is increased, understandably, the processor 31 can reduce speed for a reduction in contact risk, and/or the like to create a space for the merging vehicle in front of the subject vehicle. The cutting-in prevention control may be interpreted as control to give way to the merging vehicle on the road ahead of the subject vehicle after receiving an explicit action on merge from the merging vehicle, that is, in a negative manner.

With the above configuration, because of the operation implemented to allow the merging vehicle to merge in front of the subject vehicle on an ordinary road as much as possible, a smooth traffic society becomes feasible. Understandably, as another aspect, the processor 31 may be configured such that the merge development control is not performed when the merging vehicle is detected during automated travel on an ordinary road, whereas the merge development control is performed when the merging vehicle is detected during travel on a limited-access road. With the configuration concerned, the risk of the mutual, excessive approach of the vehicles moving at high speeds may be further reduced. By not performing the merge development control on an ordinary road, the risk of the driver of a subsequent vehicle being stressed may be reduced.

The frequency of occurrence of the merging vehicle and/or the behavior of the merging vehicle can differ depending on not only the road category but also the locality. Therefore, the processor 31 may change the response plan for a case where the merging vehicle is detected, depending on the locality in which the subject vehicle is traveling. For example, the processor 31 may be configured such that the predetermined merge development control is performed when the merging vehicle is detected during travel within a specific locality, whereas the merge development control is not performed when the merging vehicle is detected during travel without the specific locality. The specific locality in which the merge development control is performed may be preregistered as part of map data in the storage 33 and/or the like.

Next, in Automation Level 3 or higher, a second task of the driver during automated driving can be permitted. The second task is an act that the user is permitted to perform other than driving, the act being predefined. The second task can be called a secondary activity, other activities or the like. For example, acts assumed as the second task include acts of viewing content such as moving images and/or the like, operating a smartphone and/or the like, reading an e-book, having a meal with one hand, and the like. A practicable act and a prohibited act as the second task are set based on the automation level and/or the laws in the locality where the vehicle is used. The occupant condition sensor 16 such as DSM and/or the like may determine whether or not the driver is performing the second task, and then may output a signal indicating the resulting determination result to the automated driving ECU 30. The information acquisition unit F1 can acquire data indicating whether or not the driver is performing the second task, as driver condition data from the occupant condition sensor 16.

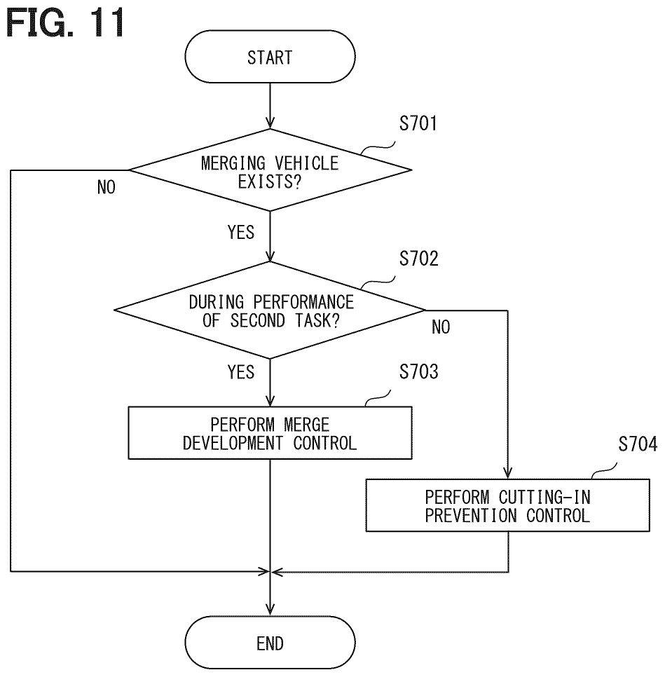

The processor 31 may change the response plan for a case where the merging vehicle is detected, depending on whether or not the driver is performing the second task during automated driving. This is because it is conceivable that the driver may desire a different system response to the merging vehicle depending on whether or not the second task is being performed. For example, as illustrated in FIG. 11, when the merging vehicle is detected, if the driver is performing the second task, the processor 31 may perform the merge development control. On the other hand, if the driver does not perform the second task, the processor 31 may perform the cutting-in prevention control. Because the driver is less concerned with the surroundings during execution of the second task, it may be expected that the driver has tolerances for the merging vehicle cutting in. With the configuration in which the merge development control is performed on condition that the second task is being executed, the risk of offensive to the driver may be reduced, while a smoother flow of traffic may be enabled. Step S701 shown in FIG. 11 is a step for determining whether or not the merging vehicle exists. Step S702 is a step for determining whether or not the driver performs the second task. Step S703 is a step for executing the merge development control based on the fact that the merging vehicle is detected during execution of the second task by the driver. Step S704 corresponds to a step for executing the cutting-in prevention control where the merging vehicle is detected under circumstances where the driver does not perform the second task. Understandably, step S704 may be a step for non-performing neither the merge development control nor the cutting-in prevention control. Step S704 may be omitted.

In the case where the merging vehicle/merge point is detected under circumstances where the driver performs the second task, the processor 31 may perform processing for making an inquiry to the driver about a response plan to the merging vehicle. For example, as the inquiry processing in question, the processor 31 may display three options to the driver on the display 21, three options being the merge development control, the cutting-in prevention control and the status quo. A reply of the driver to the inquiry can be acquired through the input apparatus 23. Even after a lapse of a predetermined response waiting time period from when the inquiry about the response plan is made, if there is no input (response) from the driver, the processor 31 may automatically determine that the merge development control is permitted. The status quo as used herein corresponds to the fact that the merge development control and the cutting-in prevention control are not performed. The status quo means to perform similar control to that where there is a predetermined distance or more away from the merge point, that is, means to maintain the normal inter-vehicle distance and the normal target speed. The processor 31 may perform the aforementioned inquiry processing on condition that the merging vehicle/merge point is detected under circumstances where the driver does not perform the second task. The processor 31 may automatically select either the merge development control or the cutting-in prevention control in accordance with the preregistered plan while the driver is performing the second task.

The processor 31 may change the response plan depending on the category/size of the vehicle attempting to merge. For example, the processor 31 may perform the merge development control where the merging vehicle is a passenger vehicle. On the other hand, the processor 31 may perform the cutting-in prevention control where the merging vehicle is a large vehicle such as a truck, a bus, a tanker truck and the like. This is because, if a large vehicle becomes the preceding vehicle, the forward visibility can be impaired and the recognition performance for lane demarcation line/road shape can be degraded. On the other hand, if the pre preceding vehicle is a large vehicle, the risk of the loss of the preceding vehicle may be reduced. Also, it is expected that the large vehicle has moderate acceleration and deceleration. Therefore, if the large vehicle is the preceding vehicle, then the effect of improving the running stability can also be expected. Therefore, the processor 31 may be set such that the merge development control is performed if the merging vehicle is the large vehicle.

The processor 31 may be configured to perform the merge development control on condition that the merging vehicle is an advanced vehicle. The advanced vehicle as used herein refers to a vehicle equipped with a predetermined level or higher of advanced safety features, such as e.g., an automated driving vehicle and the like. With the configuration concerned, the frequency of traveling the advanced vehicles including the subject vehicle in droves is increased. As a result, the safety, the stability, the fuel efficiency (electric efficiency) and/or the like in the automated driving can be improved. The processor 31 may determine whether or not the merging vehicle is the advanced vehicle, based on the discrimination result of vehicle model using image recognition or on message contents received via the vehicle-to-vehicle communication.

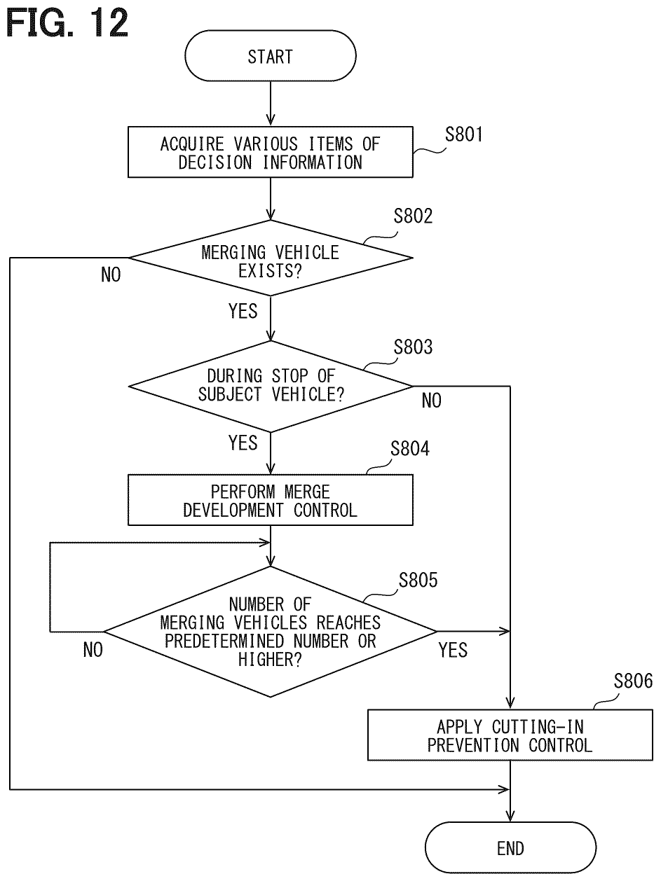

The processor 31 may be configured to perform the merge development control on condition that the subject vehicle is at stop. Merging performed while the subject vehicle is at stop can be safer than merging performed under circumstances where both the subject vehicle and the merging vehicle are moving. With the configuration concerned, improved safety regarding merging of another vehicle is achieved. FIG. 12 illustrates a flowchart corresponding to the technological idea concerned. Steps S801 to S802 shown in FIG. 12 are the same as earlier steps S101 to S102. Step S803 is a step for determining whether or not the subject vehicle is at stop. Step S804 and sequent steps are a sequence that can be executed where the subject vehicle is at stop, which includes step S804 for executing the merge development control. Step S805 is a step for determining whether or not the number of merging vehicles merging between the initial preceding vehicle and the subject vehicle reaches equal to or higher than a predetermined value. The predetermined value as used here may be the above-described permissible merge number. As illustrated in step S806 in FIG. 12, the processor 31 may execute the cutting-in prevention control where the subject vehicle does not stop and the number of merging vehicles reaches the permissible merge number.

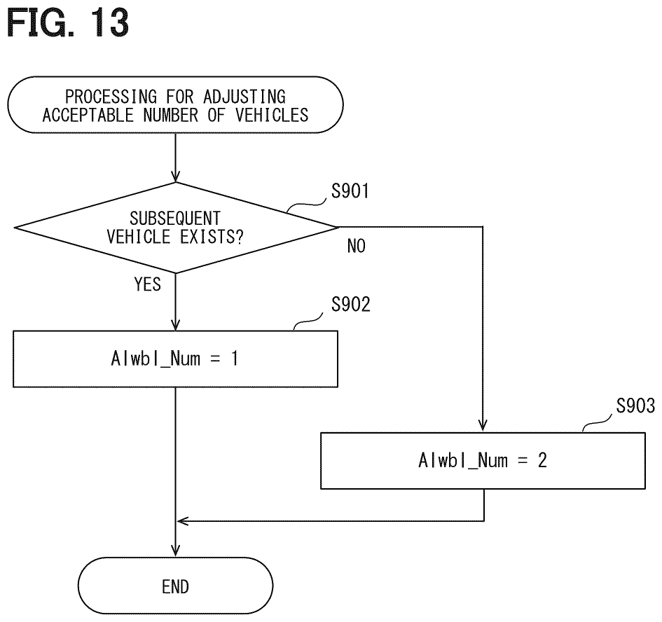

A value applied to the permissible merge number may be varied depending on the scene. For example, the processor 31 may change the permissible merge number depending on whether or not a subsequent vehicle exists, as illustrated in FIG. 13. Specifically, the processor 31 sets the permissible merge number to one (step S902) where a subsequent vehicle exists (step S901, YES). On the other hand, where no subsequent vehicle exists (step S901, NO), the processor 31 may set the permissible merge number to two, three or the like. Thus, the processor 31 may be configured such that, where no subsequent vehicle exists, a higher value is applied to the permissible merge number as compared with where the subsequent vehicle exists. “Alwbl_Num” shown in FIG. 13 is a parameter representing the permissible merge number.

With the above configuration, the application of the permissible merge number appropriate to the traveling scene result. In consequence, a smoother traffic society becomes feasible. In another way, the processor 31 may change the permissible merge number depending on whether or not traffic congestion is occurring. Specifically, the processor 31 may set the permissible merge number during traffic congestion to one. On the other hand, the processor 31 may set the permissible merge number during travels to two or higher. Setting the permissible merge number is preferably executed until the initial preceding vehicle or the subject vehicle reaches the merging start point.

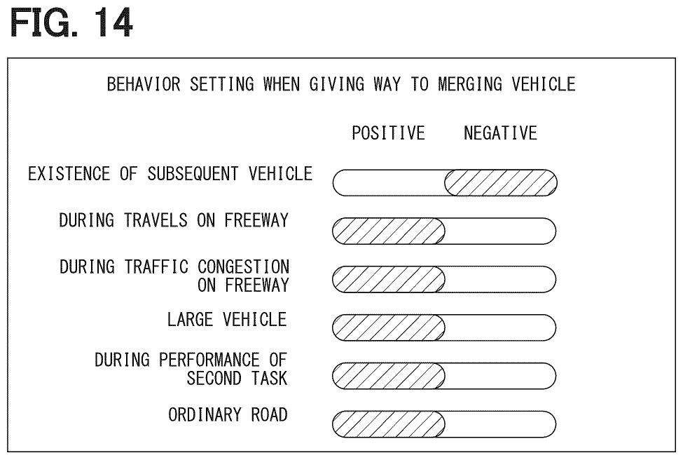

The adoption of either the merge development control or the cutting-in prevention control depending on the scene may be preregistered by the driver via a predetermined setting screen. The processor 31 can operate in accordance with the preregistered plan. FIG. 14 illustrates an example of setting screens for a response plan to the merging vehicle, in which buttons can be included for selection for each scene between positively giving the right-of-way and negatively giving the right-of-way. The control to give positively the right-of-way to the merging vehicle corresponds to the merge development control. The control to give negatively the right-of-way to the merging vehicle corresponds to the cutting-in prevention control, or alternatively, the maintenance of the normal inter-vehicle distance and/or the normal target speed. FIG. 14 illustrates the screen on which the driver makes a selection to perform a negative response to the merging vehicle where the subsequent vehicle exists, and, in other cases, to perform the control to give positively the right-of-way to the merging vehicle. The setting screen in question can be displayed on the display 21 based on a signal from the input apparatus 23.

The configuration has been described in which the recognition of the merging vehicle/approach to the merge point triggers the processor 31 to perform the control to change the inter-vehicle distance from the preceding vehicle or the subsequent vehicle, in other words, the running position of the subject vehicle in the front-rear direction. In another way, the recognition of the merging vehicle/approach to the merge point triggers the processor 31 to start the control to move temporarily from a first lane to a second lane. The move in the lateral diction is also included in the control to change the running position of the subject vehicle with respect to surrounding vehicles on the main road. The merge development control may be the control to move from the first lane to the second lane. The first lane as used herein refers to one of the lanes included in the main road, the one lane connecting with the merge road. The first lane may also be called the merged lane. The second lane refers to a lane of the lanes included in the main road other than the first lane.

### Additional Remark (1)

In the present disclosure, a program for causing the computer to function as the automated driving ECU 30, and a form of a non-transitory tangible storage medium and/or the like, such as semiconductor memory and/or the like, having the program stored therein, are included in the scope of the present disclosure. The following technological ideas related to the automated travel device are also included in the present disclosure. Further, a merging vehicle response control method, a control program, a system and/or the like corresponding to the following automated travel device are also included in the present disclosure. The merging vehicle response control method refers to a method corresponding to a control sequence executed by the automated driving ECU 30.

### Technological Idea A1

An automated travel device, includes: a vehicle control portion (Fn) that executes automated driving control to allow an own vehicle to travel autonomously along a predetermined scheduled travel route, based on a signal from a surrounding monitoring sensor; and a merge-point recognition portion (F21) that recognizes a merge point with a main road being a road on which the own vehicle travels, based on at least any one of map data, a detection result of the surrounding monitoring sensor, and data acquired from an external apparatus via wireless communications, wherein the vehicle control portion performs control to change a running position of the own vehicle with respect to surrounding vehicles on the main road, based on the fact that a remaining distance to the merge point reaches less than a predetermined value during execution of the automated driving control.

### Technological Idea A2

The automated travel device mentioned in technological idea A1, further comprising a surrounding vehicle recognition portion (F22) that recognizes a merging vehicle which is another vehicle attempting to merge at the merge point into the main road, based on either the detection result of the surrounding monitoring sensor or the data acquired from the external apparatus via wireless communications, wherein the vehicle control portion executes control to increase temporarily an inter-vehicle distance from a preceding vehicle by a predetermined amount, based on the fact that existence of the merging vehicle is recognized at the surrounding vehicle recognition portion during execution of the automated driving control.

### Technological Idea A3

The automated travel device mentioned in technological idea A2, wherein the vehicle control portion executes deceleration control to come to a stop at a position a predetermined short of the merge point either until at least one of the merging vehicle merges between the own vehicle and the preceding vehicle or until the merging vehicle disappears if the merging vehicle is recognized at the surrounding vehicle recognition portion during execution of the automated driving control.

### Technological Idea A4

The automated travel device mentioned in technological idea A3, wherein the vehicle control portion is configured to execute:
to set a scheduled stop position before the merge point if the merging vehicle is recognized at the surrounding vehicle recognition portion during execution of the automated driving control;
to execute the deceleration control to come to a stop at the scheduled stop position;
to reset the scheduled stop position to a position located a predetermined distance ahead of a current set position based on either arrival at the scheduled stop position or the fact that a remaining distance to the scheduled stop position reaches equal to or less than a predetermined value; and
to restart automated travel toward the scheduled stop position that is reset.

### Technological Idea A5

The automated travel device mentioned in technological idea A3 or A4, wherein if the merging vehicle is recognized at the surrounding vehicle recognition portion during execution of the automated driving control, the vehicle control portion provides either image display or voice output for a message indicating that there is a possibility of making a stop before the merge point.

### Technological Idea A6

The automated travel device mentioned in any one of technological ideas A3 to A5, wherein the vehicle control portion is configured to perform response plan confirmation processing for making an inquiry to a driver as to whether or not a stop made in a position a predetermined distance short of the merge point is permitted, as a response plan for a case where the merging vehicle appears during execution of the automated driving control, using a display or a speaker mounted in the own vehicle.

### Technological Idea A7

The automated travel device mentioned in any one of technological ideas A3 to A5, further comprising an environment recognition portion (F2) that determines whether or not a travel environment is traffic congestion, wherein when the merging vehicle is recognized during execution of the automated driving control, the vehicle control portion is configured to execute control to make a temporary halt in a position a predetermined distance short of the merge point if it is determined that the travel environment is the traffic congestion, but not to perform the control to make a temporary halt in a position a predetermined distance short of the merge point if it is determined that the travel environment is not the traffic congestion.

### Technological Idea A8

The automated travel device mentioned in any one of technological ideas A2 to A7, wherein if a stop is made within a predetermined distance from the merge point during execution of the automated driving control, the vehicle control portion is configured to restart travel under the automated driving control in response to a signal corresponding to either switch operation or depression of an accelerator pedal by a driver.

### Technological Idea A9

The automated travel device mentioned in any one of technological ideas A2 to A8, wherein the vehicle control portion performs a takeover request for driving operation to ask an occupant on a driver seat, in a case where there remains the merging vehicle even if a predetermined number of merging vehicles merges between the own vehicle and a preceding vehicle during execution of the automated driving control.

### Technological Idea A10

An automated travel device mentioned in any one of technological ideas A2 to A9 for use with an outward display device (18) connected thereto for displaying an image in an area which is able to be visually recognized by a driver of the merging vehicle, wherein
the vehicle control portion is configured to change an operation manner of the outward display device depending on the number of merging vehicles merging between the own vehicle and the preceding vehicle during execution of the automated driving control.

### Technological Idea A11

The automated travel device mentioned in any one of technological ideas A2 to A10, wherein if the merging vehicle is recognized at the surrounding vehicle recognition portion during execution of the automated driving control, the vehicle control portion temporarily increases, by a predetermined amount, a set value of an inter-vehicle distance as a control target in the automated driving control.

### Technological Idea A12

The automated travel device mentioned in any one of technological ideas A2 to A11, wherein if the merging vehicle is recognized at the surrounding vehicle recognition portion during execution of the automated driving control, the vehicle control portion temporarily reduces speed by a predetermined amount.

### Technological Idea A13

The automated travel device mentioned in any one of technological ideas A2 to A12, wherein the surrounding vehicle recognition portion is configured to recognize the preceding vehicle based on an input signal from the surrounding monitoring sensor, and under circumstances where the merging vehicle is recognized during execution of the automated driving control, the vehicle control portion performs control to increase an inter-vehicle distance from the preceding vehicle by a predetermined amount if the preceding vehicle exists, but the vehicle control portion selects whether a current speed is maintained or reduced mentioned in a relative position and a relative speed of the merging vehicle to the own vehicle if the preceding vehicle does not exist.

### Technological Idea A14

The automated travel device mentioned in any one of technological ideas A1 to A13, further comprising a surrounding vehicle recognition portion (F22) that recognizes a merging vehicle which is another vehicle attempting to merge at the merge point into the main road, based on either the detection result of the surrounding monitoring sensor or the data acquired from the external apparatus via wireless communications, wherein the vehicle control portion executes front space shortening control which is control to decrease temporarily an inter-vehicle distance from a preceding vehicle by a predetermined amount, based on the fact that existence of the merging vehicle is recognized at the surrounding vehicle recognition portion during execution of the automated driving control.

### Technological Idea A15

The automated travel device mentioned in technological idea A14, wherein the vehicle control portion executes the front space shortening control on condition that no traffic congestion occurs, and if traffic congestion is occurring, the vehicle control portion executes front space extension control which is control to increase an inter-vehicle distance from the preceding vehicle by a predetermined amount based on detection of the merging vehicle.

### Technological Idea A16

The automated travel device mentioned in any one of technological ideas A1 to A15, further comprising a surrounding vehicle recognition portion (F22) that recognizes a merging vehicle which is another vehicle attempting to merge at the merge point into the main road, based on either the detection result of the surrounding monitoring sensor or the data acquired from the external apparatus via wireless communications, wherein the vehicle control portion changes a response plan when the merging vehicle is recognized by the surrounding vehicle recognition portion during execution of the automated driving control, depending on either a category of a road or a locality on or in which the own vehicle is traveling.

### Technological Idea A17

The automated travel device mentioned in technological idea A16, wherein the vehicle control portion performs merge development control which is control to prompt the merging vehicle to merge in front of the own vehicle if the merging vehicle is recognized by the surrounding vehicle recognition portion during execution of the automated driving control on an ordinary road, but the vehicle control portion does not perform the merge development control if the automated driving control is being executed on a limited-access road.

### Technological Idea A18

The automated travel device mentioned in any one of technological ideas A1 to A17, further includes: a surrounding vehicle recognition portion (F22) that recognizes a merging vehicle which is another vehicle attempting to merge at the merge point into the main road, based on either the detection result of the surrounding monitoring sensor or the data acquired from the external apparatus via wireless communications; and a driver condition determination portion (F6) that determines based on an image of a driver taken by a cabin camera whether or not the driver performs a second task, wherein the vehicle control portion performs merge development control which is control to prompt the merging vehicle to merge in front of the own vehicle if the merging vehicle is recognized by the surrounding vehicle recognition portion during execution of the automated driving control and under circumstances where the driver performs the second task, but the vehicle control portion does not perform the merge development control if the driver does not perform the second task.

### Technological Idea A19

The automated travel device mentioned in any one of technological ideas A1 to A18, further includes: a surrounding vehicle recognition portion (F22) that recognizes a merging vehicle which is another vehicle attempting to merge at the merge point into the main road, based on either the detection result of the surrounding monitoring sensor or the data acquired from the external apparatus via wireless communications; and a driver condition determination portion (F6) that determines based on an image of a driver taken by a cabin camera whether or not the driver performs a second task, wherein if the merging vehicle is recognized by the surrounding vehicle recognition portion under circumstances where the driver performs the second task during execution of the automated driving control, the vehicle control portion executes processing for making an inquiry to the driver about whether or not merge development control which is control to prompt the merging vehicle to merge in front of the own vehicle is permitted to be performed.

### Technological Idea A20

The automated travel device mentioned in any one of technological ideas A1 to A19, further comprising a surrounding vehicle recognition portion (F22) that recognizes a merging vehicle which is another vehicle attempting to merge at the merge point into the main road, based on either the detection result of the surrounding monitoring sensor or the data acquired from the external apparatus via wireless communications, wherein the vehicle control portion: performs merge development control which is control to prompt the merging vehicle to merge in front of the own vehicle if the merging vehicle is recognized by the surrounding vehicle recognition portion during execution of the automated driving control; measures a number of merging vehicles which is the number of the merging vehicles merging in front of the own vehicle; and stops the merge development control if the number of merging vehicles reaches a predetermined permissible merge number.

### Technological Idea A21

The automated travel device mentioned in any one of technological ideas A1 to A20, further comprising a surrounding vehicle recognition portion (F22) that recognizes a merging vehicle which is another vehicle attempting to merge at the merge point into the main road, based on either the detection result of the surrounding monitoring sensor or the data acquired from the external apparatus via wireless communications, wherein the vehicle control portion performs merge development control which is control to prompt the merging vehicle to merge in front of the own vehicle on condition that the own vehicle is at stop under circumstances where the surrounding vehicle recognition portion recognizes the merging vehicle during execution of the automated driving control.

### Technological Idea A22

The automated travel device mentioned in any one of the technological ideas A1 to A21, wherein the vehicle control unit executes inter-vehicle distance adjustment control which is control to change the inter-vehicle distance from a preceding vehicle or a subsequent vehicle based on the fact that a remaining distance to the merge point reaches less than a predetermined value during the execution of the automated driving control.

### Technological Idea A23

The automated travel device mentioned in any one of the technological ideas A1 to A22, wherein the vehicle control unit temporarily increases a set value of an inter-vehicle distance as a control target in the automated driving control, based on the fact that a remaining distance to the merge point reaches less than a predetermined value during the execution of the automated driving control.

### Technological Idea A24

The automated travel device mentioned in any one of the technological ideas A1 to A23, wherein the vehicle control unit temporarily decreases a set value of an inter-vehicle distance as a control target in the automated driving control, based on the fact that a remaining distance to the merge point reaches less than a predetermined value during the execution of the automated driving control.

### Technological Idea A25

The automated travel device mentioned in any one of the technological ideas A1 to A24 further includes a setting acquisition unit that displays, on a display, a screen for setting a response plane when a merging vehicle is detected based on a signal from an input apparatus, and also that acquires response plan setting data which is data representing a response plan to the merging vehicle for each scene based on operation of the driver on the screen, wherein, if the existence of a merging vehicle is recognized during execution of the automated driving control, the vehicle control unit accesses the response plan setting data to perform control based on a current scene.

### Technological Idea A26

An automated travel device includes: a vehicle control unit (Fn) that executes automated driving control to allow a subject vehicle to travel autonomously along a predetermined scheduled travel route, based on a signal from a surrounding monitoring sensor; a merge-point recognition unit (F21) that recognizes a merge point with a main road being a road on which the subject vehicle travels based on at least one of map data, a detection result of the surrounding monitoring sensor, and data acquired from an external apparatus via wireless communications; and a surrounding vehicle recognition unit (F22) that recognizes a merging vehicle which is another vehicle attempting to merge at the merge point into the main road, based on either the detection result of the surrounding monitoring sensor or the data acquired from the external apparatus via wireless communications, wherein the vehicle control unit executes front space shortening control which is control to decrease temporarily an inter-vehicle distance from a preceding vehicle by a predetermined amount, based on the fact that existence of the merging vehicle is recognized at the surrounding vehicle recognition unit during execution of the automated driving control.

### Technological Idea A27

An automated travel device includes: a vehicle control unit (Fn) that executes automated driving control to allow a subject vehicle to travel autonomously along a predetermined scheduled travel route, based on a signal from a surrounding monitoring sensor; a merge-point recognition unit (F21) that recognizes a merge point with a main road being a road on which the subject vehicle travels, based on at least one of map data, a detection result of the surrounding monitoring sensor, and data acquired from an external apparatus via wireless communications; and a surrounding vehicle recognition unit (F22) that recognizes a merging vehicle which is another vehicle attempting to merge at the merge point into the main road, based on either the detection result of the surrounding monitoring sensor or the data acquired from the external apparatus via wireless communications, wherein the vehicle control unit changes a response plan when the merging vehicle is recognized by the surrounding vehicle recognition unit during execution of the automated driving control, depending on either a category of a road or a locality on or in which the subject vehicle is traveling.

### Technological Idea A28

An automated travel device includes: a vehicle control unit (Fn) that executes automated driving control to allow a subject vehicle to travel autonomously along a predetermined scheduled travel route, based on a signal from a surrounding monitoring sensor; a merge-point recognition unit (F21) that recognizes a merge point with a main road being a road on which the subject vehicle travels, based on at least one of map data, a detection result of the surrounding monitoring sensor, and data acquired from an external apparatus via wireless communications; a surrounding vehicle recognition unit (F22) that recognizes a merging vehicle which is another vehicle attempting to merge at the merge point into the main road, based on either the detection result of the surrounding monitoring sensor or the data acquired from the external apparatus via wireless communications; and a driver condition determination unit (F6) that determines based on an image of a driver taken by a cabin camera whether or not the driver performs a second task, wherein the vehicle control unit performs merge development control which is control to prompt the merging vehicle to merge in front of the subject vehicle if the merging vehicle is recognized by the surrounding vehicle recognition unit during execution of the automated driving control and under circumstances where the driver performs the second task, but the vehicle control unit does not perform the merge development control if the driver does not perform the second task.

### Technological Idea A29

An automated travel device includes: a vehicle control unit (Fn) that executes automated driving control to allow a subject vehicle to travel autonomously along a predetermined scheduled travel route, based on a signal from a surrounding monitoring sensor; a merge-point recognition unit (F21) that recognizes a merge point with a main road being a road on which the subject vehicle travels, based on at least one of map data, a detection result of the surrounding monitoring sensor, and data acquired from an external apparatus via wireless communications; and a surrounding vehicle recognition unit (F22) that recognizes a merging vehicle which is another vehicle attempting to merge at the merge point into the main road, based on either the detection result of the surrounding monitoring sensor or the data acquired from the external apparatus via wireless communications, wherein the vehicle control unit performs merge development control which is control to prompt the merging vehicle to merge in front of the subject vehicle if the merging vehicle is recognized by the surrounding vehicle recognition unit during execution of the automated driving control, measures a merging vehicle number which is the number of the merging vehicles merging in front of the subject vehicle, and stops the merge development control if the merging vehicle number reaches a predetermined permissible merge number.

### Technological Idea A30

An automated travel device includes: a vehicle control unit (Fn) that executes automated driving control to allow a subject vehicle to travel autonomously along a predetermined scheduled travel route, based on a signal from a surrounding monitoring sensor; a merge-point recognition unit (F21) that recognizes a merge point with a main road being a road on which the subject vehicle travels, based on at least one of map data, a detection result of the surrounding monitoring sensor, and data acquired from an external apparatus via wireless communications; and a surrounding vehicle recognition unit (F22) that recognizes a merging vehicle which is another vehicle attempting to merge at the merge point into the main road, based on either the detection result of the surrounding monitoring sensor or the data acquired from the external apparatus via wireless communications, wherein the vehicle control unit performs merge development control which is control to prompt the merging vehicle to merge in front of the subject vehicle on condition that the subject vehicle is at stop under circumstances where the surrounding vehicle recognition unit recognizes the merging vehicle during execution of the automated driving control.

### Technological Idea A31

An automated travel device includes: a vehicle control unit (Fn) that executes automated driving control to allow a subject vehicle to travel autonomously along a predetermined scheduled travel route, based on a signal from a surrounding monitoring sensor; a merge-point recognition unit (F21) that recognizes a merge point with a main road being a road on which the subject vehicle travels, based on at least one of map data, a detection result of the surrounding monitoring sensor, and data acquired from an external apparatus via wireless communications; and a surrounding vehicle recognition unit (F22) that recognizes a merging vehicle which is another vehicle attempting to merge at the merge point into the main road, based on either the detection result of the surrounding monitoring sensor or the data acquired from the external apparatus via wireless communications, wherein the vehicle control unit executes control to increase temporarily an inter-vehicle distance from a preceding vehicle by a predetermined amount, based on the fact that existence of the merging vehicle is recognized at the surrounding vehicle recognition unit during execution of the automated driving control.

### Additional Remark (2)

The apparatus, systems and techniques thereof described in the present disclosure may be implemented by a dedicated computer that essentially forms a processor programmed to execute one or more functions embodied by a computer program/computer programs. The apparatus and the techniques thereof described in the present disclosure may be implemented using dedicated hardware logic circuitry. Further, the apparatus and the techniques thereof described in the present disclosure may be implemented by one or more dedicated computers configured by a combination of a processor executing a computer program and one or more hardware logic circuits. For example, some or all of the functions equipped in the processor 31 may be implemented as hardware. An aspect for implementing a certain function as hardware includes an aspect for implementing using one or more ICs and/or the like. CPU, MPU, GPU and DFP (Date Flow Processor) and/or the like are adoptable as a processor (arithmetic core). Some or all of the functions equipped in the processor 31 may be implemented by a combination of a plurality of types of arithmetic processing devices. Some or all of the functions equipped in the processor 31 may be implemented using a SoC (System-On-Chip), FPGA, ASIC and/or the like. FPGA stands for Field-Programmable Gate Array. ASIC stands for Application Specific Integrated Circuit. The computer program may be stored in a computer-readable non-transitory tangible storage medium as instructions executed by the computer. A HDD (Hard-Disk Drive), a SSD (Solid State Drive), flash memory and/or the like are adoptable as a program storage medium.

What is claimed is:

1. An automated travel device, comprising:
a vehicle control unit configured to execute automated driving control to allow a subject vehicle to travel autonomously along a predetermined scheduled travel route based on a signal from a surrounding monitoring sensor;
a merge-point recognition unit configured to recognize a merge point with a main road, on which the subject vehicle travels, based on at least one of map data, a detection result of the surrounding monitoring sensor, or data acquired from an external apparatus via wireless communications; and
a surrounding vehicle recognition unit configured to recognize a merging vehicle, which is an other vehicle attempting to merge at the merge point into the main road, based on at least one of the detection result of the surrounding monitoring sensor or the data acquired from the external apparatus via wireless communications, wherein
the vehicle control unit is configured, during execution of the automated driving control,
to perform control to change a running position of the subject vehicle with respect to a surrounding vehicle on the main road, when a remaining distance to the merge point reaches less than a predetermined value,
the control to change the running position of the subject vehicle with respect to the surrounding vehicle on the main road includes control to increase temporarily an inter-vehicle distance from a preceding vehicle by a predetermined amount, during execution of the automated driving control, and when the surrounding vehicle recognition unit recognizes the merging vehicle, and
the vehicle control unit is configured, during execution of the automated driving control,
to perform a takeover request to an occupant on a driver seat to ask a driving operation, when a predetermined number of merging vehicles merge between the subject vehicle and a preceding vehicle, and when the merging vehicles remain.

2. The automated travel device according to claim 1, wherein
the automated travel device is to be connected with an outward display device that is configured to display an image in an area, which is visually recognizable by a driver of the merging vehicle, and
the vehicle control unit is configured, during execution of the automated driving control,
to change an operation manner of the outward display device depending on a number of merging vehicles merging between the subject vehicle and the preceding vehicle.

3. The automated travel device according to claim 1, wherein
the vehicle control unit is configured, during execution of the automated driving control,
to temporarily increase a set value of the inter-vehicle distance, which is a control target of the automated driving control, by a predetermined amount, when the surrounding vehicle recognition unit recognizes the merging vehicle.

4. The automated travel device according to claim 1, wherein
the vehicle control unit is configured to, during execution of the automated driving control,
temporarily reduce speed by a predetermined amount, when the surrounding vehicle recognition unit recognizes the merging vehicle.

5. The automated travel device according to claim 1, wherein
the surrounding vehicle recognition unit is configured to recognize the preceding vehicle based on an input signal from the surrounding monitoring sensor, and
the vehicle control unit is configured to, during execution of the automated driving control, and when the merging vehicle is recognized,
perform control to increase an inter-vehicle distance from the preceding vehicle by a predetermined amount, when the preceding vehicle exists,
select whether to maintain a current speed or reduce the current speed according to a relative position and a relative speed of the merging vehicle with respect to the subject vehicle, when the preceding vehicle does not exist.

6. An automated travel device, comprising:
a vehicle control unit configured to execute automated driving control to allow a subject vehicle to travel autonomously along a predetermined scheduled travel route based on a signal from a surrounding monitoring sensor;
a merge-point recognition unit configured to recognize a merge point with a main road, on which the subject vehicle travels, based on at least one of map data, a detection result of the surrounding monitoring sensor, or data acquired from an external apparatus via wireless communications; and
a surrounding vehicle recognition unit configured to recognize a merging vehicle, which is an other vehicle attempting to merge at the merge point into the main road, based on at least one of the detection result of the surrounding monitoring sensor or the data acquired from the external apparatus via wireless communications, wherein
the vehicle control unit is configured, during execution of the automated driving control,
to perform control to change a running position of the subject vehicle with respect to a surrounding vehicle on the main road, when a remaining distance to the merge point reaches less than a predetermined value, and
the vehicle control unit is configured to, during execution of the automated driving control, and when the surrounding vehicle recognition unit recognizes the merging vehicle,
execute front space shortening control to decrease temporarily an inter-vehicle distance from a preceding vehicle by a predetermined amount, when no traffic congestion occurs, and
execute front space extension control to increase the inter-vehicle distance from the preceding vehicle by a predetermined amount, when traffic congestion occurs.

7. An automated travel device, comprising:
a vehicle control unit configured to execute automated driving control to allow a subject vehicle to travel autonomously along a predetermined scheduled travel route based on a signal from a surrounding monitoring sensor;
a merge-point recognition unit configured to recognize a merge point with a main road, on which the subject vehicle travels, based on at least one of map data, a detection result of the surrounding monitoring sensor, or data acquired from an external apparatus via wireless communications; and
a surrounding vehicle recognition unit configured to recognize a merging vehicle, which is an other vehicle attempting to merge at the merge point into the main road, based on at least one of the detection result of the surrounding monitoring sensor or the data acquired from the external apparatus via wireless communications, wherein
the vehicle control unit is configured, during execution of the automated driving control,
to perform control to change a running position of the subject vehicle with respect to a surrounding vehicle on the main road, when a remaining distance to the merge point reaches less than a predetermined value,
the vehicle control unit is configured to
perform merge development control to prompt the merging vehicle to merge in front of the subject vehicle, when the surrounding vehicle recognition unit recognizes the merging vehicle, during execution of the automated driving control on an ordinary road, and
not to perform the merge development control, during execution of the automated driving control on a limited-access road.

8. An automated travel device, comprising:
a vehicle control unit configured to execute automated driving control to allow a subject vehicle to travel autonomously along a predetermined scheduled travel route based on a signal from a surrounding monitoring sensor;
a merge-point recognition unit configured to recognize a merge point with a main road, on which the subject vehicle travels, based on at least one of map data, a detection result of the surrounding monitoring sensor, or data acquired from an external apparatus via wireless communications;
a surrounding vehicle recognition unit configured to recognize a merging vehicle, which is an other vehicle attempting to merge at the merge point into the main road, based on at least one of the detection result of the surrounding monitoring sensor or the data acquired from the external apparatus via wireless communications; and
a driver condition determination unit configured to determine whether the driver performs a second task based on an image of a driver taken by a cabin camera, wherein
the vehicle control unit is configured, during execution of the automated driving control,
to perform control to change a running position of the subject vehicle with respect to a surrounding vehicle on the main road, when a remaining distance to the merge point reaches less than a predetermined value, and
the vehicle control unit is configured, during execution of the automated driving control, and when the surrounding vehicle recognition unit recognizes the merging vehicle,
to perform merge development control to prompt the merging vehicle to merge in front of the subject vehicle, when the driver performs the second task, and
not perform the merge development control when the driver does not perform the second task.

9. An automated travel device, comprising:
a vehicle control unit configured to execute automated driving control to allow a subject vehicle to travel autonomously along a predetermined scheduled travel route based on a signal from a surrounding monitoring sensor;
a merge-point recognition unit configured to recognize a merge point with a main road, on which the subject vehicle travels, based on at least one of map data, a detection result of the surrounding monitoring sensor, or data acquired from an external apparatus via wireless communications;
a surrounding vehicle recognition unit configured to recognize a merging vehicle, which is an other vehicle attempting to merge at the merge point into the main road, based on at least one of the detection result of the surrounding monitoring sensor or the data acquired from the external apparatus via wireless communications; and
a driver condition determination unit configured to determine whether the driver performs a second task based on an image of a driver taken by a cabin camera, wherein
the vehicle control unit is configured, during execution of the automated driving control,
to perform control to change a running position of the subject vehicle with respect to a surrounding vehicle on the main road, when a remaining distance to the merge point reaches less than a predetermined value, and
the vehicle control unit is configured, during execution of the automated driving control, when the surrounding vehicle recognition unit recognizes the merging vehicle,
to execute processing to inquire the driver whether the driver permits merge development control to prompt the merging vehicle to merge in front of the subject vehicle, when the driver performs the second task.
